(19) United States
(12) Patent Application Publication
(10) Pub. No.: US 2025/0275552 A1
(43) Pub. Date: Sep. 4, 2025

(54) TREATED SOY PROTEIN PRODUCT AND METHOD OF MAKING THE SAME

(71) Applicant: Cargill, Incorporated, Wayzata, MN (US)

(72) Inventors: Yara Licceth BENAVIDES PAZ, Plymouth, MN (US); Alexandra Jean FIEGEL, Albertville, MN (US); Chathurada Sugeeshvarie GAJADEERA, Plymouth, MN (US); Daniel Scott GASPARD, Victoria, MN (US); Mohammad Sharif KHAN, Rogers, MN (US); Erika Lyn MCCONVILLE, Golden Valley, MN (US); Michael Alan MORTENSON, Rogers, MN (US); Michael Arthur PORTER, Maple Grove, MN (US)

(73) Assignee: Cargill, Incorporated, Wayzata, MN (US)

(21) Appl. No.: 18/862,285

(22) PCT Filed: May 8, 2023
(86) PCT No.: PCT/US2023/021390

§ 371 Date: Nov. 1, 2024

Related U.S. Application Data
(60) Provisional application No. 63/364,280, filed on May 6, 2022.

(51) Int. Cl. A23J 3/16; A23J 1/14; A23J 3/22; A23J 3/26; A23L 11/00; A23L 11/30

(52) U.S. Cl. CPC A23J 3/16; A23J 1/14; A23J 3/227; A23J 3/26; A23L 11/07; A23L 11/32

(57) ABSTRACT

The disclosure relates to a treated soy protein product and a method of making the same. The method comprises providing an extruded soy protein material and performing a washing step on the extruded soy protein material to generate the treated soy protein product. The treated soy protein product has at least 70% protein on a dry basis. Further, the disclosure relates to a treated soy protein product having an increased protein content, and preferably a reduced flavor component content, compared to an unwashed extruded soy protein material.

### CROSS-REFERENCE TO RELATED APPLICATIONS

This application claims the benefit of U.S. Provisional Patent Application No. 63/364,280, filed May 6, 2022, which is hereby incorporated by reference in its entirety.

### BACKGROUND

Extruded soy protein products have long been used for extending processed meat products and as bases for meat analogs. A conventional way to make extruded soy protein concentrate products involves extracting untoasted defatted soy flakes with 70 wt % ethanol: 30 wt % water to remove the soluble sugars without dissolving the protein. The resulting product is desolventized and milled to become the soy protein concentrate products. The product can then be extruded into forms useful in extending meat products.

One of the major problems for the above manufacturing method is that since ethanol is explosive, more expensive and complex facilities and solvent recovery systems are required.

In meat analogs, the issue of protein concentration is important and there is a demand to have meat analogs with higher protein concentration by a more simplified manufacturing process. Thus, a treated soy protein product having a higher protein content and an improved method for making such product is needed.

### SUMMARY

The present disclosure provides a method of making a treated soy protein product comprising the steps of providing an extruded soy protein material, and performing a washing step on the extruded soy protein material to obtain the treated soy protein product. The washing step comprises washing the extruded soy protein material at a washing temperature of room temperature to 85° C. with a washing agent. The ratio of the washing agent to the extruded soy protein material used in the washing step is 4:1 to 40:1. The treated soy protein product has at least 70 wt % protein on a dry basis. Also described herein is the treated soy protein product produced by the above method.

The present disclosure also provides a treated soy protein product having one or more improved attributes compared to an unwashed extruded soy protein material. The one or more improved attributes are selected from the group consisting of an increased protein content, a reduced flavor component content, a reduced metal ion content, a reduced odor content, a reduced carbohydrate content, a reduced free amino acid content, and any combinations thereof.

### BRIEF DESCRIPTION OF THE FIGURES

The drawings illustrate generally, by way of example, but not by way of limitation, various aspects discussed in the present document.

FIG. 1 shows the protein concentration (dry basis) recovered after washing extruded soy flour at different combinations of pH values of the initial washing agents and washing temperatures. The numbers on the contours indicate the predicted concentration at the set of combinations of pH values of the initial washing agents and washing temperatures.

FIG. 2 shows the protein concentration (dry basis) recovered from the extract after washing extruded soy flour at different combinations of pH values of the initial washing agents and washing temperatures. The numbers on the contours indicate the predicted concentration at the set of combinations of pH values of the initial washing agents and washing temperatures.

FIG. 3 shows the percentage of protein extracted by washing extruded soy flour at different combinations of pH values of the initial washing agents and washing temperatures. The numbers on the contours indicate the predicted percentage at the set of combinations of pH values of the initial washing agents and washing temperatures.

FIG. 4 shows effect of washing agent composition on protein concentration of the treated soy protein products.

FIG. 5 shows effect of washing agent composition on residual sugar concentration of the treated soy protein products.

FIG. 6 shows changes in protein concentration, mass, and protein yield with successive washes in washing extruded soy bean meal.

FIG. 7 shows changes in concentrations of compounds in the washed and unwashed samples.

### DETAILED DESCRIPTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Unless defined otherwise, all technical and scientific terms used herein have the same meaning as commonly understood by one skilled in the art to which this invention belongs. As used herein, each of the following terms has the meaning associated with it as defined below.

Unless expressly stated, ppm (parts per million), percentage, and ratios are based on a dry weight basis. Percentage based on a dry weight basis is also referred to as wt % below.

The term “for example,” “for instance,” “such as,” or “including” as used herein is meant to introduce examples that further clarify more general subject matter. Unless otherwise specified, these examples are provided only as an aid for understanding the applications illustrated in the present disclosure and are not meant to be limiting in any fashion.

As used herein, the term “extruded” refers to a description for a material that has undergone an extrusion process. For example, an “extruded material” refers to a material that has passed through an extruder (using single or twin-screw configurations), together with sufficient water to create an “extruded product”. Historically, some extruded protein ingredients have been called textured vegetable protein, textured soy protein, or various other names indicating a protein type after extrusion.

During the most common type of protein extrusion, a hydrated protein ingredient is heated while shearing such that an extruded mass reaches above the boiling point of water. The extruded mass passes through an orifice such that there is a sudden change in pressure and the water boils creating steam. The steam expands the structure resulting in an extruded structure. Regulation of the pressure drop, temperature, moisture, and feed rate allow one skilled in the art to create different sizes, shapes, and textures of extruded products. The extruded product can be dried in a variety of conventional dryers or used without drying in the invention described here.

As used herein. “room temperature” or “RT” refers to a temperature between 20° C. to 25° C.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

Described herein is a treated soy protein product and a method of making the treated soy protein product. The treated soy protein product has at least 70 weight percent (wt %) protein on a dry basis. The treated soy protein product is suitable for use as a protein source for incorporation into foods for human and/or animal consumption.

### Method of Making Treated Soy Protein Product

A method of making a treated soy protein product described in the present disclosure comprises the steps of: (a) providing an extruded soy protein material, and (b) performing a washing step on the extruded soy protein material at a washing temperature of room temperature to 85° C. with a washing agent to obtain the treated soy protein product. The washing agent to the extruded soy protein material used in the washing step is in a ratio of 4:1 to 40:1.

In one aspect, the treated soy protein product has one or more improved attributes compared to the extruded soy protein material. Preferably, the one or more improved attributes may include, but may not be limited to, an increased protein content, a reduced flavor component content, a reduced metal ion content, a reduced odor content, a reduced carbohydrate content, a reduced free amino acid content, or any combinations thereof.

In one aspect, the extruded soy protein material includes, but is not limited to, extruded soy flour and extruded soy bean meal. The extruded soy protein material can have a protein content (initial protein content) of 45 wt %, 48 wt %, 50 wt %, 52 wt %, 55 wt %, 57 wt %, or 60 wt %. For example, the extruded soy protein material can have a protein content can be a range of 45 to 60 wt %, 45 to 55 wt %, 45 to 52 wt %, 45 to 50 wt %, 45 to 48 wt %, 48 to 60 wt %, 48 to 57 wt %, 48 to 52 wt %, 48 to 50 wt %, 50 to 60 wt %, 50 to 57 wt %, 50 to 55 wt %, 52 to 60 wt %, 52 to 57 wt %, 52 to 55 wt %, 55 to 60 wt %, or 55 to 57 wt %.

Preferably, the extruded soy protein material is extruded soy protein flour.

In one aspect, the protein content of the treated soy protein product can be at least 68 w1%, 70 wt %, 72.5 wt %, 75 wt %, 78 wt %, on a dry basis. For example, the protein content of the treated soy protein product can be in a range of 68 to 78 wt %, 68 to 75 wt %, 70 to 72.5%, 72.5 to 78 wt, or 72.5 to 75 wt % on a dry basis.

Preferably, the treated soy protein product is extruded soy protein concentrate.

In one aspect, the washing temperature can be room temperature, 45° C., 50° C., 55° C., 60° C., 65° C., 70° C., 75° C., 80° C., or 85° C. For example, the washing temperature can be in a range of room temperature to 85° C., room temperature to 80° C., room temperature to 75° C., room temperature to 70° C., room temperature to 65° C. room temperature to 60° C., room temperature to 55° C., room temperature to 50° C., room temperature to 45° C., 45 to 85° C., 45 to 80° C., 45 to 75° C., 45 to 70° C., 45 to 60° C., 50 to 85° C., 50 to 80° C., 50 to 75° C., 50 to 70° C., 50 to 65° C., 55 to 85° C., 55 to 80° C. 55 to 75° C. 55 to 70° C. 60 to 85° C. 60 to 80° C. 60 to 75° C. 65 to 85° C. 65 to 80° C., or 65 to 75° C.

Preferably, the washing temperature can be in a range of room temperature to 85° C., more preferably of 65 to 75° C.

In one aspect, a washing agent can be water (e.g., tap water or deionized water) or water with an acid added. The added acid component can decrease the initial pH during washing.

In an aspect, the pH of the washing agent can be 4, 4.15, 4.55, 4.85, 5, 5.15, 5.45 or 5.75. For example, the pH of the washing agent can be in a range of 4 to 5.75, 4 to 5.45, 4 to 5.15, 4 to 4.85, 4 to 4.55, 4.15 to 5.75, 4.15 to 5.45, 4.15 to 5.15, 4.15 to 4.85, 4.25 to 5.75, 4.25 to 5.45, 4.25 to 5.15, 4.25 to 4.85, 4.25 to 4.55, 4.55 to 5.75, 4.55 to 5.45, 4.55 to 5.15, 4.55 to 4.85, 4.75 to 5.25, 4.85 to 5.75, 4.85 to 5.45, 4.85 to 5.15, 5.15 to 5.75, 5.15 to 5.45, or 5.45 to 5.75.

In one aspect, salts can be added to water as a washing agent.

In one aspect, duration of the washing step can be 10 minutes, 15 minutes, 20 minutes, 25 minutes, or 30 minutes. For example, the duration can be in a range of 10 to 30 minutes, 10 to 25 minutes, 10 to 20 minutes, 15 to 30 minutes, or 15 to 25 minutes.

In one aspect, the washing step is a co-current washing or countercurrent washing. When a countercurrent washing scheme is used, a smaller total volume of washing agent would be used but the duration of the entire washing period would be the same.

In an aspect, the washing step can be performed for one time, at least one time, two times, at least twice, three times, or at least thrice. The washing temperature, the duration, the washing agent, and/or pH of the washing agent used in each washing step can be the same or different.

For example, a washing agent for a first washing step (initial washing agent) can be water with an acid added. The pH of the initial washing agent can be 4 to 5.75, preferably 4.25 to 5.25. Washing agent(s) for subsequent washing step(s) (subsequent washing agent(s)) can be water having the same or, preferably, different pH from the pH of the initial washing agent.

In one aspect, the washing agent to the extruded soy protein material in the washing step can be in a ratio of 4:1 to 40:1, from 4:1 to 35:1, from 4:1 to 30:1, from 4:1 to 25:1, from 4:1 to 20:1, from 4:1 to 15:1, 4:1 to 10:1, 4:1 to 7:1, 4:1 to 6:1, 4:1 to 5:1, 5:1 to 10:1, 5:1 to 9:1, 5:1 to 8:1, 5:1 to 7:1, 6:1 to 10:1, 6:1 to 8:1, or 6:1 to 5:1. In an aspect, the washing agent to the extruded soy protein material in the washing step can be in a ratio of 5:1, 6:1, or 8:1. For example, the extruded soy protein material can be washed using countercurrent extraction at a ratio of 5:1, in 6:1, or 10:1. In one aspect, the ratio of the washing agent to the extruded soy protein material in each washing step can be the same or different.

Preferably, the washing step can be performed three times and the ratio of the washing agent to the extruded soy protein material in each washing step can be from 4:1 to 10:1, preferably from 5:1 to 10:1.

Preferably, the ratio of the washing agent to the extruded soy protein material is a weight ratio.

In one aspect, the method also includes a step of drying the treated soy protein product at a drying temperature of 75° C., 80° C., 85° C., 90° C., 95° C., 100° C., 105° C., 110° C., 115° C., or 120° C. For example, the treated soy protein product can be dried at a drying temperature in a range of 75 to 120° C., 80 to 115° C., 85 to 110° C., 90° C., to 120° C., 90° C., to 110° C., 95° C., to 120° C., 95° C., to 115° C., 95° C., to 105° C., 100° C., to 120° C., 100° C., to 115° C., 100° C., to 110° C., 105° C., to 120° C., 105° C., to 110° C., or 110° C., to 120° C. A skilled artesian would appreciate that the treated soy protein product can be dried under different drying methods with different drying parameters.

In one aspect, the method optionally comprises a step of pre-drying the extruded soy protein material before the washing step.

In one aspect, the extruded soy protein material can be provided directly from an extruder to the washing step without any intermittent pre-drying step before washing. Preferably, the extruded soy protein material has a moisture content of from 15 to 25%, more preferably from 18 to 20%. The advantage of avoiding the pre-drying step is that only one drying step is required throughout the entire process, so resources required for the pre-drying step (e.g., costs, energy, equipment) can be saved.

Method of Making Extruded Soy Protein Concentrate from Extruded Soy Flour

In one aspect, this disclosure also describes a method of making an extruded soy protein concentrate from an extruded soy flour. The method consists of steps of: (a) providing an extruded soy flour, and (b) performing a washing step on the extruded soy flour to obtain the extruded soy protein concentrate. The washing step consists of washing the extruded soy flour at a washing temperature of room temperature to 85° C., preferably of 45 to 85° C., more preferably of 65 to 75° C., with water. The resulting extruded soy protein concentrate has at least 70 wt % protein, preferably at least 72.5 wt % protein, on a dry basis. The water to the extruded soy flour in the washing step is in a ratio of 4:1 to 40:1, preferably 4:1 to 10:1.

In an aspect, the washing steps are carried out three times to generate the extruded soy protein concentrate from the extruded soy flour. The washing temperature, the duration of washing, the washing agent, and/or pH of the washing agent (i.e., water) used in each washing step can be the same or, preferably, different. For example, in a first washing step, water with an acid added can be used as an initial washing and the pH of the initial washing agent can be in a range of 4.00 to 5.75. In a second and/or third washing step (subsequent washing steps), water having the same or, preferably, different pH from the pH of the initial washing agent can be used as subsequent washing agents.

In one aspect, a ratio of the water to the extruded soy flour in each washing step can be the same or different. For example, the ratio of water to the extruded soy flour in all the washing steps is the same (e.g., 5:1).

In another aspect, the extruded soy flour is washed using countercurrent extraction at a ratio of water to the extruded soy flour 4:1 to 40:1, preferably 4:1 to 10:1, more preferably of 5:1.

In one aspect, the extruded soy protein concentrate is dried at a drying temperature of 75° C., to 120° C., preferably of 100 to 110° C. A skilled artesian would appreciate that the extruded soy protein concentrate can be dried under different drying methods with different drying parameters.

Method of Making Extruded Soy Protein Concentrate from Extruded Soybean Meal

A feed-grade treated soy protein product can be made using the method disclosed in the present disclosure when an extruded soybean meal is used as the starting material.

In one aspect, a method of making an extruded soy protein concentrate from an extruded soy bean meal is described. The method consists of steps of: (a) providing an extruded soy bean meal, and (b) performing a washing step on the extruded soy bean meal to obtain the extruded soy protein concentrate. The washing step consists of washing the extruded soybean meal at a washing temperature of room temperature with water. The resulting extruded soy protein concentrate has at least 70 wt % protein on a dry basis. The water to the extruded soy bean meal in the washing step is in a ratio of 4:1 to 40:1, preferably 4:1 to 10:1.

In an aspect, the washing steps are carried out three times to generate the extruded soy protein concentrate from the extruded soybean meal. The washing temperature, the duration of washing, the washing agent, and/or pH of the washing agent (i.e., water) used in each washing step can be the same or different.

In one aspect, a ratio of the water to the extruded soy bean meal in each washing step can be the same or different. For example, the ratio of the water to the extruded soybean meal in the first washing step is 8:1, and the ratios in the second and third washing steps are 6:1. In another example, the ratios of the water to the extruded soybean meal in all the three washing steps are 5:1. In another aspect, the extruded soybean meal is washed using countercurrent extraction.

In one aspect, the extruded soy protein concentrate derived from soybean meal was dried at a drying temperature of 75° C., to 120° C., preferably of 100 to 110° C. A skilled artesian would appreciate that the extruded soy protein concentrate can be dried under different drying methods with different drying parameters.

### Method of Washing Extruded Soy Protein Material

In one aspect, this disclosure also describes a method of washing an extruded soy protein material. The method comprises steps of: (a) washing the extruded soy protein material at a washing temperature of from room temperature to 85° C. with a washing agent in a ratio of, washing agent to extruded soy protein material, from 4:1 to 40:1 to obtain a washed material, and (b) drying the washed material at a drying temperature of 75° C., to 120° C., to obtain a treated soy protein product. The resulting treated soy protein product has one or more improved attributes compared to the extruded soy protein material.

Preferably, the one or more improved attributes may include, but may not be limited to, an increased protein content, a reduced flavor component content, a reduced metal ion content, a reduced odor content, a reduced carbohydrate content, a reduced free amino acid content, or any combinations thereof.

Preferably, the treated soy protein product has a protein content of at least 70 wt % on a dry basis.

In one aspect, one or more process parameters of the method are the same or different in each washing step. Preferably, the one or more process parameters may include, but may not be limited to, a ratio of the washing agent to the extruded soy protein material, pH of the washing agent, washing temperature, duration of washing, or any combinations thereof.

Preferably, the present invention provides a method of increasing protein content in a treated soy protein product by washing an extruded soy protein material, wherein the treated soy protein product has an increased protein content compared to the extruded soy protein material: more preferably, the washing process is described in this disclosure, such as in paragraphs [0024] to [0058].

Preferably, the present invention provides a method of reducing flavor component content in a treated soy protein product by washing an extruded soy protein material, wherein the treated soy protein product has a reduced flavor content compared to the extruded soy protein material: more preferably, the washing process is described in this disclosure, such as in paragraphs [0024] to [0058].

Preferably, the present invention provides a method of reducing metal ion content in a treated soy protein product by washing an extruded soy protein material, wherein the treated soy protein product has a reduced metal ion content compared to the extruded soy protein material; more preferably, the washing process is described in this disclosure, such as in paragraphs [0024] to [0058].

Preferably, the present invention provides a method of reducing odor content in a treated soy protein product by washing an extruded soy protein material, wherein the treated soy protein product (i.e., washed extrude soy protein material) has a reduced metal ion content compared to the extruded soy protein material (i.e., unwashed starting material): more preferably, the washing process is described in this disclosure, such as in paragraphs [0024] to [0058].

Preferably, the present invention provides a method of reducing carbohydrate content, preferably a soluble carbohydrate content, in an treated soy protein product by washing an extruded soy protein material, wherein the treated soy protein product (i.e., washed extrude soy protein material) has a reduced metal ion content compared to the extruded soy protein material (i.e., unwashed starting material): more preferably, the washing process is described in this disclosure, such as in paragraphs [0024] to [0058].

Preferably, the present invention provides a method of reducing free amino acid content in a treated soy protein product by washing an extruded soy protein material, wherein the treated soy protein product (i.e., washed extrude soy protein material) has a reduced metal ion content compared to the extruded soy protein material (i.e., unwashed starting material): more preferably, the washing process is described in this disclosure, such as in paragraphs [0024] to [0058].

### Treated Soy Protein Product

Preferably, the treated soy protein product of the present invention, made by any method described in this disclosure, has one or more improved attributes as compared to an unwashed extruded soy protein material. Examples of an unwashed extruded soy protein material may include, but may not be limited to, an extruded soy protein starting material of the present invention (e.g., extruded soy flour, extruded soybean meal) that has not been subjected to the washing process of the present invention as described in this disclosure.

Preferably, the one or more improved attributes may include, but may not be limited to: an increased protein content, a reduced flavor component content, a reduced metal ion content, a reduced odor content, a reduced carbohydrate content, a reduced free amino acid content, or any combinations thereof.

Preferably, the treated soy protein product described in this disclosure has an increased protein content as compared to an unwashed extruded soy protein material. In one aspect, the treated soy protein product of the present invention may have a protein content of at least 70 wt %, preferably at least 75 wt %, more preferably at least 78 w1%, on a dry basis.

Preferably, the treated soy protein product described in this disclosure has a reduced flavor component content as compared to an unwashed extruded soy protein material. In other words, the content of one or more flavor components in the treated soy protein product described in this disclosure is lower compared to an unwashed extruded soy protein material. Flavor components are substances present in treated soy protein product that impart a flavor (e.g., earthy, savory, meaty, brothy, grainy, cereal, malty, toasted, beany, green) to the treated soy protein product. Examples of the flavor components may include, but may not be limited to, furan, pyran, organic acid, aldehyde, alcohol, ketone, pyrazine, lactone, thiol, sulfides, or any combinations thereof.

In one aspect, the treated soy protein product described in this disclosure may have a lower furan content, preferably a lower 2-pentyl-furan. 2-ethyl-furan. 2-butyl-furan, and/or 2-propyl-furan content, compared to an unwashed extruded soy protein material. Furans detectable by humans upon tasting may be so potent that they cannot be identified or quantified by conventional analytical chemistry and yet be decreased by the treatment of this invention.

Preferably, the treated soy protein product described in this disclosure may have furan content that is at least 86%, preferably at least 90%, more preferably at least 95%, even more preferably at least 99% lower than the furan content of an unwashed extruded soy protein material. For example, the treated soy protein product may have a 2-pentyl-furan content that is at least 90%, preferably at least 95%, more preferably at least 99% lower than the 2-pentyl-furan content of an unwashed extruded soy protein material. The treated soy protein product may have a 2-ethyl-furan content that is at least 90%, preferably at least 95%, more preferably at least 99% lower than the 2-ethyl-furan content of an unwashed extruded soy protein material. The treated soy protein product may have a 2-butyl-furan content that is at least 86%, preferably at least 88%, more preferably at least 91% lower than the 2-butyl-furan content of an unwashed extruded soy protein material. The treated soy protein product may have a 2-propyl-furan content that is at least 90%, preferably at least 95%, more preferably at least 99% lower than the 2-propyl-furan content of an unwashed extruded soy protein material.

In one aspect, the treated soy protein product described in this disclosure may have a lower aldehyde content, preferably a lower hexanal, benzaldehyde, heptanal, octanal, 2,4-decandienal, tolualdehyde, and/or 4-ethyl-benzaldehyde content, compared to an unwashed extruded soy protein material. Aldehydes detectable by humans upon tasting may be so potent that they cannot be identified or quantified by conventional analytical chemistry and yet be decreased by the treatment of this invention.

Preferably, the treated soy protein product described in this disclosure may have aldehyde content that is at least 8%, preferably at least 50%, more preferably at least 75%, even more preferably at least 84% lower than the aldehyde content of an unwashed extruded soy protein material. For example, the treated soy protein product may have a hexanal content that is at least 51%, preferably at least 65%, more preferably at least 80% lower than the hexanal content of an unwashed extruded soy protein material. The treated soy protein product may have a benzaldehyde content that is at least 72%, preferably at least 78%, more preferably at least 84% lower than the benzaldehyde content of an unwashed extruded soy protein material. The treated soy protein product may have a heptanal content that is at least 68%, preferably at least 75%, more preferably at least 83% lower than the heptanal content of an unwashed extruded soy protein material. The treated soy protein product may have an octanal content that is at least 28%, preferably at least 50%, more preferably at least 53% lower than the octanal content of an unwashed extruded soy protein material. The treated soy protein product may have a 2,4-decandienal content that is at least 8%, preferably at least 21%, more preferably at least 34% lower than the 2,4-decandienal content of an unwashed extruded soy protein material. The treated soy protein product may have a tolualdehyde content that is at least 59%, preferably at least 70%, more preferably at least 82% lower than the tolualdehyde content of an unwashed extruded soy protein material. The treated soy protein product may have a 4-ethyl-benzaldehyde content that is at least 50%, preferably at least 60%, more preferably at least 69% lower than the 4-ethyl-benzaldehyde content of an unwashed extruded soy protein material.

In one aspect, the treated soy protein product described in this disclosure may have a lower alcohol content, preferably a lower 1-octen-3-ol, 2-ethyl-1-hexanol. 1-pentanol, and/or 2-hexanol content, compared to an unwashed extruded soy protein material. Alcohols detectable by humans upon tasting may be so potent that they cannot be identified or quantified by conventional analytical chemistry and yet be decreased by the treatment of this invention.

Preferably, the treated soy protein product described in this disclosure may have alcohol content that is at least 55%, preferably at least 70%, more preferably at least 90%, even more preferably at least 99% lower than the alcohol content of an unwashed extruded soy protein material. For example, the treated soy protein product may have a 1-octen-3-ol content that is at least 80%, preferably at least 83%, more preferably at least 86% lower than the 1-octen-3-ol content of an unwashed extruded soy protein material. The treated soy protein product may have a 2-ethyl-1-hexanol content that is at least 55%, preferably at least 62%, more preferably at least 70% lower than the 2-ethyl-1-hexanol content of an unwashed extruded soy protein material. The treated soy protein product may have a 1-pentanol content that is at least 82%, preferably at least 84%, more preferably at least 87% lower than the 1-pentanol content of an unwashed extruded soy protein material. The treated soy protein product may have a 2-hexanol content that is at least 90%, preferably at least 95%, more preferably at least 99% lower than the 2-hexanol content of an unwashed extruded soy protein material.

In one aspect, the treated soy protein product described in this disclosure may have a lower ketone content, preferably a lower 2-heptanone, 2-octanone, 2-nonanone, and/or 2-hexanone content, compared to an unwashed extruded soy protein material.

Preferably, the treated soy protein product described in this disclosure may have ketone content that is at least 87%, preferably at least 90%, more preferably at least 92%, even more preferably at least 95% lower than the ketone content of an unwashed extruded soy protein material. For example, the treated soy protein product may have a 2-heptanone content that is at least 89%, preferably at least 90%, more preferably at least 92% lower than the 2-heptanone content of an unwashed extruded soy protein material. The treated soy protein product may have a 2-octanone content that is at least 87%, preferably at least 89%, more preferably at least 91% lower than the 2-octanone content of an unwashed extruded soy protein material. The treated soy protein product may have a 2-nonanone content that is at least 87%, preferably at least 88%, more preferably at least 89% lower than the 2-nonanone content of an unwashed extruded soy protein material. The treated soy protein product may have a 2-hexanone content that is at least 90%, preferably at least 95%, more preferably at least 99% lower than the 2-hexanone content of an unwashed extruded soy protein material. Ketones detectable by humans upon tasting may be so potent that they cannot be identified or quantified by conventional analytical chemistry and yet be decreased by the treatment of this invention.

In one aspect, the treated soy protein product described in this disclosure may have a lower pyrazine content, preferably a lower 2-ethyl-6-methyl-pyrazine content, compared to an unwashed extruded soy protein material. Pyrazines detectable by humans upon tasting may be so potent that they cannot be identified or quantified by conventional analytical chemistry and yet be decreased by the washing treatment of this invention.

Preferably, the treated soy protein product described in this disclosure may have pyrazine content that is at least 10%, preferably at least 50%, more preferably at least 95%, even more preferably at least 99% lower than the pyrazine content of an unwashed extruded soy protein material. For example, the treated soy protein product may have a 2-ethyl-6-methyl-pyrazine content that is at least 14%, preferably at least 58%, more preferably at least 99% lower than the 2-ethyl-6-methyl-pyrazine content of an unwashed extruded soy protein material.

Preferably, the treated soy protein product described in this disclosure may have one or more flavor components content at least 20%, preferably at least 40%, more preferably at least 50%, lower than the one or more flavor components content of an unwashed extruded soy protein material. The one or more flavor components may include, but may not be limited to, 2-hexanol, 2-hexanone, 2-propyl-furan, 2-ethyl-furan, or 2-heptanone, 2-octanone, 2-butyl-furan, 2-nonanone, 1-octen-3-ol, benzaldehyde, heptanal, tolualdehyde, 2-pentyl-furan, hexanal, 2-ethyl-1-hexanol, 4-ethyl-benzaldehyde, octanal, 2,4-decandienal, or any combinations thereof.

More preferably, the treated soy protein product described in this disclosure may have one or more flavor component content is at least 90%, preferably at least 95%, more preferably at least 99%, lower than the one or more flavor components content of an unwashed extruded soy protein material. The one or more flavor components may include, but may not be limited to, 2-hexanol, 2-hexanone, 2-propyl-furan, or any combinations thereof.

In one aspect, the treated soy protein product described in this disclosure may have 2-pentyl-furan in an amount less than 1,170 ppb, preferably less than 760 ppb: hexanal in an amount less than 720 ppb, preferably less than 480 ppb: benzaldehyde in an amount less than 100 ppb, preferably less than 80 ppb: heptanal in an amount less than 40 ppb, preferably less than 30 ppb: 1-octen-3-ol in an amount less than 40 ppb, preferably less than 25 ppb: octanal in an amount less than 30 ppb, preferably less than 20 ppb: 2-heptanone in an amount less than 20 ppb, preferably less than 15 ppb: 2-ethyl-1-hexanol in an amount less than 15 ppb, preferably less than 10 ppb; 2,4-decandienal in an amount less than 15 ppb, preferably less than 7 ppb: 2-ethyl-furan in an amount less than 10 ppb, preferably less than 8 ppb; 2-butyl-furan in an amount less than 10 ppb, preferably less than 5 ppb; 2-octanone in an amount less than 35 ppb, preferably less than 8 ppb; 2,4-nonadienal in an amount less than 7 ppb, preferably less than 2 ppb; 2-ethyl-6-methyl-pyrazine in an amount less than 6 ppb, preferably less than 4 ppb; 2-octanone in an amount less than 4 ppb, preferably less than 3 ppb; tolualdehyde in an amount less than 4 ppb, preferably less than 2 ppb; 2-nonanone in an amount less than 3 ppb, preferably less than 2.5 ppb; 4-ethyl-benzaldehyde in an amount less than 2 ppb, preferably less than 1.5 ppb; 1-pentanol in an amount less than 1.5 ppb, preferably less than 1 ppb; 2-hexanol in an amount less than 0.1 ppb, preferably less than 0.01 ppb; 2-hexanone in an amount less than 0.1 ppb, preferably less than 0.01 ppb; and/or 2-propyl-furan in an amount less than 0.1 ppb, preferably less than 0.01 ppb; or any combinations thereof.

Preferably, the treated soy protein product described in this disclosure may be free of 2-hexanol, 2-hexanone, or 2-propyl-furan, or any combinations thereof.

Preferably, the treated soy protein product described in this disclosure has a reduced metal ion content as compared to an unwashed extruded soy protein material. In other words, the content of one or more metal ions in the treated soy protein product described in this disclosure is lower compared to an unwashed extruded soy protein material. Examples of metal ions may include, but may not be limited to, calcium ion, copper ion, iron ion, potassium ion, magnesium ion, sodium ion, or any combination thereof.

Preferably, the treated soy protein product described in this disclosure may have one or more ions content that is at least 10%, preferably at least 30%, more preferably at least 50%, lower than the one or more ions content of an unwashed extruded soy protein material. The one or more metal ions may include, but may not be limited to, copper ion, potassium ion, magnesium ion, or any combinations thereof.

In one aspect, the treated soy protein product may have a copper ion content that is at least 10%, preferably at least 13%, more preferably at least 15% lower than the copper ion content of an unwashed extruded soy protein material. The treated soy protein product may have a potassium ion content that is at least 70%, preferably at least 75%, more preferably at least 80% lower than the potassium ion content of an unwashed extruded soy protein material. The treated soy protein product may have a magnesium ion content that is at least 40%, preferably at least 45%, more preferably at least 50% lower than the magnesium ion content of an unwashed extruded soy protein material.

In one aspect, the treated soy protein product may have a phosphorus content that is at least 20%, preferably at least 25%, more preferably at least 30% lower than the phosphorus content of an unwashed extruded soy protein material.

Preferably, the treated soy protein product described in this disclosure has a reduced odor content as compared to an unwashed extruded soy protein material.

Preferably, the treated soy protein product described in this disclosure has a reduced carbohydrate content, preferably a reduced soluble carbohydrate content, as compared to an unwashed extruded soy protein material. In other words, the content of one or more carbohydrates in the treated soy protein product described in this disclosure is lower compared to an unwashed extruded soy protein material. Examples of carbohydrate may include, but may not be limited to, sucrose, raffinose, stachyose, or any combinations thereof. Preferably, the carbohydrates are soluble carbohydrates.

Preferably, the treated soy protein product described in this disclosure may have one or more carbohydrates content that is at least 75%, preferably at least 80%, more preferably at least 85%, lower than the one or more carbohydrates content of an unwashed extruded soy protein material. The one or more soluble carbohydrates may include, but may not be limited to, sucrose, raffinose, stachyose, or any combinations thereof.

In one aspect, the treated soy protein product may have a sucrose content that is at least 70%, preferably at least 75%, more preferably at least 81% lower than the sucrose content of an unwashed extruded soy protein material. The treated soy protein product may have a raffinose content that is at least 75%, preferably at least 80%, more preferably at least 82% lower than the raffinose content of an unwashed extruded soy protein material. The treated soy protein product may have a stachyose content that is at least 70%, preferably at least 75%, more preferably at least 79% lower than the stachyose content of an unwashed extruded soy protein material.

In one aspect, the treated soy protein product may have sucrose in an amount less than 71,000 ppm, preferably less than 14,000 ppm: raffinose in an amount less than 10,000 ppm, preferably less than 2,000 ppm: stachyose in an amount of less than 49,000 ppm, preferably less than 11,000 ppm: or any combinations thereof.

Preferably, the treated soy protein product described in this disclosure has a reduced free amino acid content as compared to an unwashed extruded soy protein material. In other words, the content of one or more free amino acids in the treated soy protein product described in this disclosure is lower compared to an unwashed extruded soy protein material. Examples of free amino acids may include, but may not be limited to, histidine, serine, arginine, aspartic acid, glycine, glutamic acid, threonine, alanine, tyrosine, methionine, valine, tryptophan, phenylalanine, isoleucine, leucine, lysine, or any combinations thereof.

Preferably, the treated soy protein product described in this disclosure may have one or more free amino acids content that is at least 80%, preferably at least 85%, more preferably at least 90%, lower than the one or more free amino acids content of an unwashed extruded soy protein material. The one or more free amino acids may include, but may not be limited to, aspartic acid, glutamic acid, alanine, valine, or any combinations thereof.

In one aspect, the treated soy protein product may have a histidine content that is at least 68%, preferably at least 69%, more preferably at least 71% lower than the histidine content of an unwashed extruded soy protein material. The treated soy protein product may have a serine content that is at least 69%, preferably at least 73%, more preferably at least 76% lower than the serine content of an unwashed extruded soy protein material. The treated soy protein product may have an arginine content that is at least 78%, preferably at least 79%, more preferably at least 80% lower than the stachyose content of an unwashed extruded soy protein material. The treated soy protein product may have an aspartic acid content that is at least 85%, preferably at least 86%, more preferably at least 87% lower than the aspartic acid content of an unwashed extruded soy protein material. The treated soy protein product may have a glycine content that is at least 38%, preferably at least 44%, more preferably at least 50% lower than the glycine content of an unwashed extruded soy protein material. The treated soy protein product may have a glutamic acid content that is at least 85%, preferably at least 86%, more preferably at least 87% lower than the glutamic acid content of an unwashed extruded soy protein material. The treated soy protein product may have a threonine content that is at least 73%, preferably at least 74%, more preferably at least 75% lower than the threonine content of an unwashed extruded soy protein material. The treated soy protein product may have an alanine content that is at least 80%, preferably at least 81%, more preferably at least 82% lower than the alanine content of an unwashed extruded soy protein material. The treated soy protein product may have a tyrosine content that is at least 56%, preferably at least 59%, more preferably at least 62% lower than the glycine content of an unwashed extruded soy protein material. The treated soy protein product may have a methionine content that is at least 66%, preferably at least 67%, more preferably at least 68% lower than the methionine content of an unwashed extruded soy protein material. The treated soy protein product may have a valine content that is at least 80%, preferably at least 81%, more preferably at least 82% lower than the valine content of an unwashed extruded soy protein material. The treated soy protein product may have a tryptophan content that is at least 69%, preferably at least 70%, more preferably at least 71% lower than the tryptophan content of an unwashed extruded soy protein material. The treated soy protein product may have a phenylalanine content that is at least 75%, preferably at least 76%, more preferably at least 77% lower than the phenylalanine content of an unwashed extruded soy protein material. The treated soy protein product may have an isoleucine content that is at least 77%, preferably at least 78%, more preferably at least 79% lower than the isoleucine content of an unwashed extruded soy protein material. The treated soy protein product may have a leucine content that is at least 76%, preferably at least 77%, more preferably at least 78% lower than the leucine content of an unwashed extruded soy protein material. The treated soy protein product may have a lysine content that is at least 75%, preferably at least 76%, more preferably at least 77% lower than the glycine content of an unwashed extruded soy protein material.

In one aspect, the treated soy protein product described in this disclosure may have histidine in an amount less than 20 ppm, preferably less than 17 ppm; serine in an amount less than 10 ppm, preferably less than 9 ppm; arginine in an amount less than 180 ppm, preferably less than 160 ppm; aspartic acid in an amount less than 95 ppm, preferably less than 80 ppm; glycine in an amount less than 130 ppm, preferably less than 110 ppm; glutamic acid in an amount less than 120 ppm, preferably less than 100 ppm; threonine in an amount less than 12 ppm, preferably less than 10 ppm; alanine in an amount less than 40 ppm, preferably less than 30 ppm; tyrosine in an amount less than 55 ppm, preferably less than 48 ppm; methionine in an amount less than 8 ppm, preferably less than 7 ppm; valine in an amount less than 15 ppm, preferably less than 11 ppm; tryptophan in an amount less than 95 ppm, preferably less than 85 ppm; phenylalanine in an amount less than 30 ppm, preferably less than 25 ppm; isoleucine in an amount less than 15 ppm, preferably less than 13 ppm; leucine in an amount less than 15 ppm, preferably less than 12 ppm, lysine in an amount less than 20 ppm, preferably less than 15 ppm; total free amino acids in an amount less than less than 800 ppm, preferably less than 750 ppm and more preferably less than 730 ppm; or any combinations thereof.

In another aspect, the treated soy protein product of the present invention, made by any method described in this disclosure, has one or more improved attributes as compared to an equivalent unwashed extruded soy protein product. The term “equivalent unwashed extruded soy protein product” as used herein refers to a treated soy protein product produced from the same starting material (e.g., from extruded soy flour of the same batch) which has been treated in the same way (e.g., same extrusion process, if any) except that it has not been subjected to the washing process of the present invention as described in this disclosure.

Preferably, the one or more improved attributes may include, but may not be limited to: an increased protein content, a reduced flavor component content, a reduced metal ion content, a reduced odor content, a reduced carbohydrate content, a reduced free amino acid content, or any combinations thereof.

Preferably, the treated soy protein product described in this disclosure has an increased protein content as compared to an equivalent unwashed extruded soy protein product.

Preferably, the treated soy protein product described in this disclosure has a reduced flavor component content as compared to an equivalent unwashed extruded soy protein product. Examples of the flavor components may include, but may not be limited to, furan, pyran, organic acid, aldehyde, alcohol, ketone, pyrazine, lactone, thiol, sulfide, or any combinations thereof.

In one aspect, the treated soy protein product described in this disclosure may have a lower aldehyde content, preferably a lower benzaldehyde and/or 2,4-nonadienal content, compared to an equivalent unwashed extruded soy protein product.

In one aspect, the treated soy protein product described in this disclosure may have a lower pyrazine content, preferably a lower 2-ethyl-6-methyl-pyrazine content, compared to an equivalent unwashed extruded soy protein product.

In one aspect, the content of one or more flavor components in the treated soy protein product described in this disclosure is lower compared to an equivalent unwashed extruded soy protein product. Examples of the one or more flavor components may include, but may not be limited to, 1-octen-3-ol, 1-pentanol, 2-ethyl-1-hexanol, 2-hexanol, hexanal, heptanal, benzaldehyde, octanal, 4-ethyl-benzaldehyde, 2,4-nonadienal, and 2,4-decandienal, tolualdehyde, 2-heptanone, 2-octanone, 2-nonanone, 2-pentyl-furan, 2-ethyl-furan, 2-butyl-furan, 2-propyl-furan, 2-ethyl-6-methyl-pyrazine, or any combinations thereof. Preferably, the treated soy protein product has a lower content in benzaldehyde, 2,4-nonadienal, and 2-ethyl-6-methyl-pyrazine compared to an equivalent unwashed extruded soy protein product.

Preferably, the treated soy protein product described in this disclosure has a reduced metal ion content as compared to an equivalent unwashed extruded soy protein product. In other words, the content of one or more metal ions in the treated soy protein product described in this disclosure is lower compared to an equivalent unwashed extruded soy protein product. Examples of metal ions may include, but may not be limited to, calcium ion, copper ion, iron ion, potassium ion, magnesium ion, sodium ion, or any combinations thereof. Preferably, the treated soy protein product has a lower content in iron, magnesium, and potassium compared to an equivalent unwashed extruded soy protein product.

Preferably, the treated soy protein product described in this disclosure has a reduced carbohydrate content, preferably a reduced soluble carbohydrate content, as compared to an equivalent unwashed extruded soy protein product. In other words, the content of one or more soluble carbohydrates in the treated soy protein product described in this disclosure is lower compared to an equivalent unwashed extruded soy protein product. Examples of carbohydrate may include, but may not be limited to, sucrose, raffinose, stachyose, or any combinations thereof. Preferably, the carbohydrates are soluble carbohydrates; more preferably, the treated soy protein product has a lower raffinose content compared to an equivalent unwashed extruded soy protein product.

Preferably, the treated soy protein product described in this disclosure has a reduced free amino acid content as compared to an equivalent unwashed extruded soy protein product. In other words, the content of one or more free amino acids in the treated soy protein product described in this disclosure is lower compared to an equivalent unwashed extruded soy protein product. Examples of free amino acids may include, but may not be limited to, histidine, serine, arginine, aspartic acid, glycine, glutamic acid, threonine, alanine, tyrosine, methionine, valine, tryptophan, phenylalanine, isoleucine, leucine, lysine, or any combinations thereof. Preferably, the treated soy protein product has a lower content in histidine, serine, arginine, aspartic acid, and lysine compared to an equivalent unwashed extruded soy protein product.

In another aspect, the present invention also relates to a treated soy protein product that has one or more attributes as described below. Preferably, the treated soy protein product is made or washed by any method of the present invention as described in this disclosure.

Preferably, the treated soy protein product may have 2-pentyl-furan in an amount less than 1,170 ppb, preferably less than 760 ppb; hexanal in an amount less than 720 ppb, preferably less than 480 ppb; benzaldehyde in an amount less than 100 ppb, preferably less than 80 ppb; heptanal in an amount less than 40 ppb, preferably less than 30 ppb; 1-octen-3-ol in an amount less than 40 ppb, preferably less than 25 ppb; octanal in an amount less than 30 ppb, preferably less than 20 ppb; 2-heptanone in an amount less than 20 ppb, preferably less than 15 ppb; 2-ethyl-1-hexanol in an amount less than 15 ppb, preferably less than 10 ppb; 2,4-decandienal in an amount less than 15 ppb, preferably less than 7 ppb; 2-ethyl-furan in an amount less than 10 ppb, preferably less than 8 ppb; 2-butyl-furan in an amount less than 10 ppb, preferably less than 5 ppb; 2-octanone in an amount less than 35 ppb, preferably less than 8 ppb; 2,4-nonadienal in an amount less than 7 ppb, preferably less than 2 ppb; 2-ethyl-6-methyl-pyrazine in an amount less than 6 ppb, preferably less than 4 ppb; 2-octanone in an amount less than 4 ppb, preferably less than 3 ppb; tolualdehyde in an amount less than 4 ppb, preferably less than 2 ppb; 2-nonanone in an amount less than 3 ppb, preferably less than 2.5 ppb; 4-ethyl-benzaldehyde in an amount less than 2 ppb, preferably less than 1.5 ppb; 1-pentanol in an amount less than 1.5 ppb, preferably less than 1 ppb; 2-hexanol in an amount less than 0.1 ppb, preferably less than 0.01 ppb; 2-hexanone in an amount less than 0.1 ppb, preferably less than 0.01 ppb; 2-propyl-furan in an amount less than 0.1 ppb, preferably less than 0.01 ppb; or any combinations thereof.

Preferably, the treated soy protein product may have sucrose in an amount less than 71,000 ppm, preferably less than 14,000 ppm; raffinose in an amount less than 10,000 ppm, preferably less than 2,000 ppm; stachyose in an amount of less than 49,000 ppm, preferably less than 11,000 ppm; or any combinations thereof.

Preferably, the treated soy protein product may have histidine in an amount less than 20 ppm, preferably less than 17 ppm; serine in an amount less than 10 ppm, preferably less than 9 ppm; arginine in an amount less than 180 ppm, preferably less than 160 ppm; aspartic acid in an amount less than 95 ppm, preferably less than 80 ppm; glycine in an amount less than 130 ppm, preferably less than 110 ppm; glutamic acid in an amount less than 120 ppm, preferably less than 100 ppm; threonine in an amount less than 12 ppm, preferably less than 10 ppm; alanine in an amount less than 40 ppm, preferably less than 30 ppm; tyrosine in an amount less than 55 ppm, preferably less than 48 ppm; methionine in an amount less than 8 ppm, preferably less than 7 ppm; valine in an amount less than 15 ppm, preferably less than 11 ppm; tryptophan in an amount less than 95 ppm, preferably less than 85 ppm; phenylalanine in an amount less than 30 ppm, preferably less than 25 ppm; isoleucine in an amount less than 15 ppm, preferably less than 13 ppm; leucine in an amount less than 15 ppm, preferably less than 12 ppm, lysine in an amount less than 20 ppm, preferably less than 15 ppm; total free amino acids in an amount less than less than 800 ppm, preferably less than 750 ppm and more preferably less than 730 ppm; or any combinations thereof.

In another aspect, the present invention also relates to a treated soy protein product that has one or more attributes as described below. Preferably, the treated soy protein product is subjected to the washing process of the present invention as described in this disclosure.

Preferably, the treated soy protein product may have 2-pentyl-furan in an amount less than 1,170 ppb, preferably less than 760 ppb; hexanal in an amount less than 720 ppb, preferably less than 480 ppb; benzaldehyde in an amount less than 100 ppb, preferably less than 80 ppb; heptanal in an amount less than 40 ppb, preferably less than 30 ppb; 1-octen-3-ol in an amount less than 40 ppb, preferably less than 25 ppb; octanal in an amount less than 30 ppb, preferably less than 20 ppb; 2-heptanone in an amount less than 20 ppb, preferably less than 15 ppb; 2-ethyl-1-hexanol in an amount less than 15 ppb, preferably less than 10 ppb; 2,4-decandienal in an amount less than 15 ppb, preferably less than 7 ppb; 2-ethyl-furan in an amount less than 10 ppb, preferably less than 8 ppb; 2-butyl-furan in an amount less than 10 ppb, preferably less than 5 ppb; 2-octanone in an amount less than 35 ppb, preferably less than 8 ppb; 2,4-nonadienal in an amount less than 7 ppb, preferably less than 2 ppb; 2-ethyl-6-methyl-pyrazine in an amount less than 6 ppb, preferably less than 4 ppb; 2-octanone in an amount less than 4 ppb, preferably less than 3 ppb; tolualdehyde in an amount less than 4 ppb, preferably less than 2 ppb; 2-nonanone in an amount less than 3 ppb, preferably less than 2.5 ppb; 4-ethyl-benzaldehyde in an amount less than 2 ppb, preferably less than 1.5 ppb; 1-pentanol in an amount less than 1.5 ppb, preferably less than 1 ppb; 2-hexanol in an amount less than 0.1 ppb, preferably less than 0.01 ppb; 2-hexanone in an amount less than 0.1 ppb, preferably less than 0.01 ppb; 2-propyl-furan in an amount less than 0.1 ppb, preferably less than 0.01 ppb; or any combinations thereof.

Preferably, the treated soy protein product may have sucrose in an amount less than 71,000 ppm, preferably less than 14,000 ppm; raffinose in an amount less than 10,000 ppm, preferably less than 2,000 ppm; stachyose in an amount of less than 49,000 ppm, preferably less than 11,000 ppm; or any combinations thereof.

Preferably, the treated soy protein product may have histidine in an amount less than 20 ppm, preferably less than 17 ppm; serine in an amount less than 10 ppm, preferably less than 9 ppm; arginine in an amount less than 180 ppm, preferably less than 160 ppm; aspartic acid in an amount less than 95 ppm, preferably less than 80 ppm; glycine in an amount less than 130 ppm, preferably less than 110 ppm; glutamic acid in an amount less than 120 ppm, preferably less than 100 ppm; threonine in an amount less than 12 ppm, preferably less than 10 ppm; alanine in an amount less than 40 ppm, preferably less than 30 ppm; tyrosine in an amount less than 55 ppm, preferably less than 48 ppm; methionine in an amount less than 8 ppm, preferably less than 7 ppm; valine in an amount less than 15 ppm, preferably less than 11 ppm; tryptophan in an amount less than 95 ppm, preferably less than 85 ppm; phenylalanine in an amount less than 30 ppm, preferably less than 25 ppm; isoleucine in an amount less than 15 ppm, preferably less than 13 ppm; leucine in an amount less than 15 ppm, preferably less than 12 ppm, lysine in an amount less than 20 ppm, preferably less than 15 ppm; total free amino acids in an amount less than less than 800 ppm, preferably less than 750 ppm and more preferably less than 730 ppm; or any combinations thereof.

In one aspect, the attributes, other than the ones described above, of the treated soy protein product produced or treated (e.g., washed) by any method described in this disclosure can be improved as compared to the unwashed extruded soy protein material. Such attributes may include, but may not be limited to, taste, color, or any combinations thereof.

### EXAMPLES

The invention is further described in detail by reference to the following experimental examples. These examples are provided for purposes of illustration only and are not intended to be limiting unless otherwise specified. Thus, the invention should in no way be construed as being limited to the following examples, but rather should be construed to encompass any and all variations which become evident as a result of the teaching provided herein.

### Example 1

### Materials and Method

Extruded soy flour was washed three times in this example to produce extruded soy protein concentrate.

Water at different pH values can be prepared as an initial washing agent in a first wash. Water was pre-heated in a water bath at a target washing temperature. To achieve a target pH value, a desired amount of an acid solution (e.g., a standard 4M hydrochloric acid HCl) was added to 100 g of the pre-heated water to obtain the initial washing agent at the target pH value.

The first wash began when samples of 20 g extruded soy flour (Cargill Incorporated) were mixed with 100 g of the initial washing agent, prepared according to the treatment conditions in Table 1, for 10 to 15 seconds. The mixture was returned to the water bath at the washing temperature for 10 minutes. The mixture was then quickly spread onto a 250 micron screen in a uniform bed and a weight was placed on top to facilitate drainage of the first wash and retrieve the first-washed solids.

TABLE 1
Treatment conditions for washing extruded soy flour.

| Treatment | pH of initial | Temperature |
|---|---|---|
| Condition | washing agent | (° C.) |
| 1 | 4.62 | 67.5 |
| 2 | 5.38 | 67.5 |
| 3 | 4.62 | 52.5 |
| 4 | 4.62 | 67.5 |
| 5 | 5.38 | 67.5 |
| 6 | 5.00 | 60.0 |
| 7 | 4.62 | 52.5 |
| 8 | 5.38 | 52.5 |
| 9 | 5.38 | 52.5 |
| 10 | 5.00 | 60.0 |
| 11 | 5.38 | 52.5 |
| 12 | 4.75 | 60.0 |
| 13 | 5.00 | 66.0 |
| 14 | 4.25 | 75.0 |
| 15 | 5.25 | 60.0 |
| 16 | 5.75 | 75.0 |
| 17 | 5.00 | 60.0 |
| 18 | 4.25 | 45.0 |
| 19 | 5.75 | 45.0 |
| 20 | 5.38 | 67.5 |
| 21 | 4.62 | 67.5 |
| 22 | 4.62 | 52.5 |
| 23 | 5.00 | 54.0 |

After 5 minutes or upon completion of the drainage of the first wash, a second wash began when 100 g of fresh water pre-heated at the corresponding washing temperature was added to the first-washed solids and mixed for 10 to 15 seconds. The mixture was returned to the water bath at the washing temperature for 10 minutes. The filtrates were transferred to a bottle, filtered, dried and analyzed for mass and protein loss. The pH of the first-washed solids was measured to confirm the desired pH was achieved.

After 5 minutes or upon completion of the drainage of the second wash, second-washed solids were retrieved. A third wash began when 100 g of fresh water pre-heated at the corresponding washing temperature was added to the second-washed solids and mixed for 10 to 15 seconds. The mixture was returned to the water bath at the washing temperature for 10 minutes. Extruded soy protein concentrates were generated upon completion of drainage of the third wash.

The extruded soy protein concentrates were weighed and moisture contents of the extruded soy protein concentrates were measured. The extruded soy protein filtrates were then dried at 110° C., to obtain extract solids.

Protein concentrations of the extruded soy protein concentrates and the extract solids were determined by nitrogen analysis in which a TruMac® analyzer (Model 630-300-300, LECO Corporation, St. Joseph, Mich.) and a nitrogen-to-protein conversion factor of 6.25 were used.

### Results and Discussion

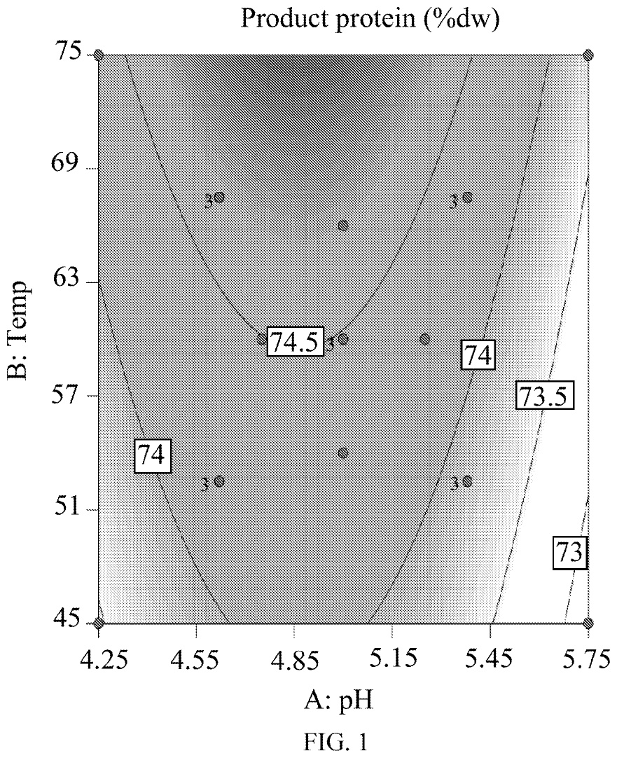

Both the washing temperature and pH values of the initial washing agents (initial pH) influenced the protein concentration (dry basis) in the extruded soy protein concentrates (p=0.0121), with a relationship being described by Equation 1 and illustrated in FIG. 1. The highest protein concentrations were found between about pH 4.6 and 5.3 and at washing temperatures greater than about 60° C. Further, as shown in FIG. 1, the protein concentrations in the extruded soy protein concentrates were consistently above 72.5%, which was well above the requirement for commercially common product.

$$Protein concentration = 34.454 + ( 15.74471 \times pH ) + ( 0.029499 \times Temperature ) - ( 1.61853 \times {pH}^{2} ) \qquad Equation 1$$

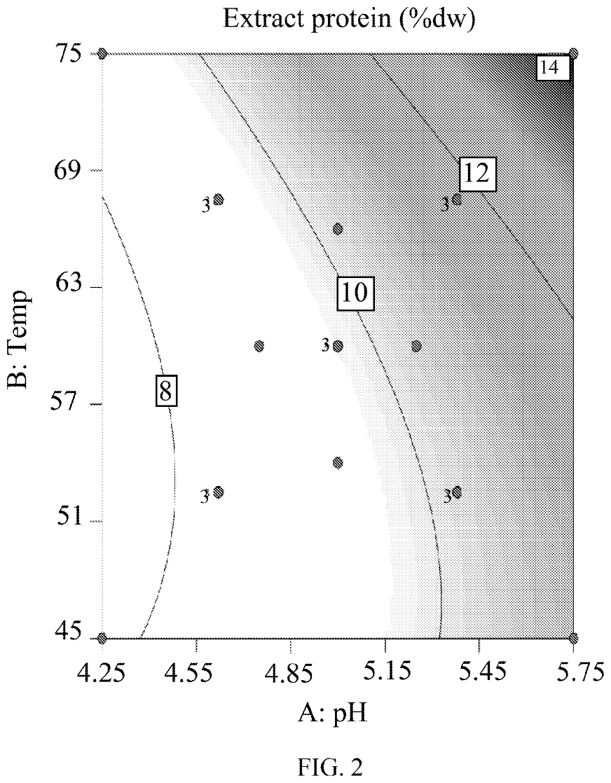

The protein concentration in the extracts was also affected by the initial pH and washing temperature conditions (p<0.0001). This relationship was illustrated in FIG. 2. The more acidic conditions and lower temperature corner of FIG. 2 indicated the lowest protein concentration in the extract.

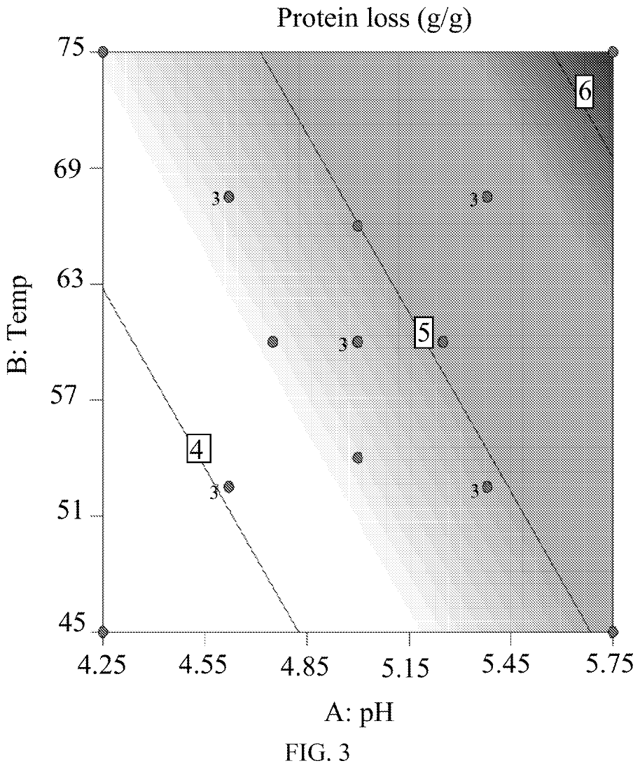

A better expression of protein loss was obtained by computing the protein in the extract as a function of the protein in the original sample of the extruded soy flour (i.e., initial protein content). The protein loss, expressed as a percent of the initial protein content, was significantly (p<0.0001) affected by both washing temperature and initial pH. The relationship was illustrated in FIG. 3. As shown, protein loss was minimized when both the washing temperature and initial pH were lower.

### CONCLUSION

The conditions for retaining the maximum amount of protein in the treated soy protein products were found at an initial pH between 4.75 and 5.25 and washing temperature between 65° C., and at least 75° C. The data suggested that protein loss was decreased at lower washing temperatures and initial pH.

### Example 2

### Materials and Method

The compositions of washing agents used are shown in Table 2.

TABLE 2
Compositions of washing agents.

| Washing | Water | Ethanol |
|---|---|---|
| Agent | (wt %) | (wt %) |
| 1 | 100 | 0 |
| 2 | 75 | 25 |
| 3 | 50 | 50 |
| 4 | 25 | 75 |
| 5 | 0 | 100 |

One sample of 30 g extruded soy flour (Cargill Incorporated) was suspended in 200 g of each of the five washing agents, held for 15 minutes at room temperature and then the washing agent was removed by pouring through a 250-micron screen. The solids were resuspended in fresh washing agent, held for another 15 minutes and collected. The wash was repeated for a third time for 15 minutes to generate the extruded soy protein concentrate. The washed samples (i.e., the extruded soy protein concentrate) were spread out on aluminum foil and dried in an oven at 90-100° C., overnight.

The five washed samples and one unwashed sample of extruded soy flour were extracted with water and analyzed for soluble sugars by high pressure liquid chromatography. Protein concentrations of the washed and unwashed samples were determined by the nitrogen analysis in which a TruMac® analyzer (Model 630-300-300, LECO Corporation, St. Joseph, Mich.) and a nitrogen-to-protein conversion factor of 6.25 were used.

### Results and Discussion

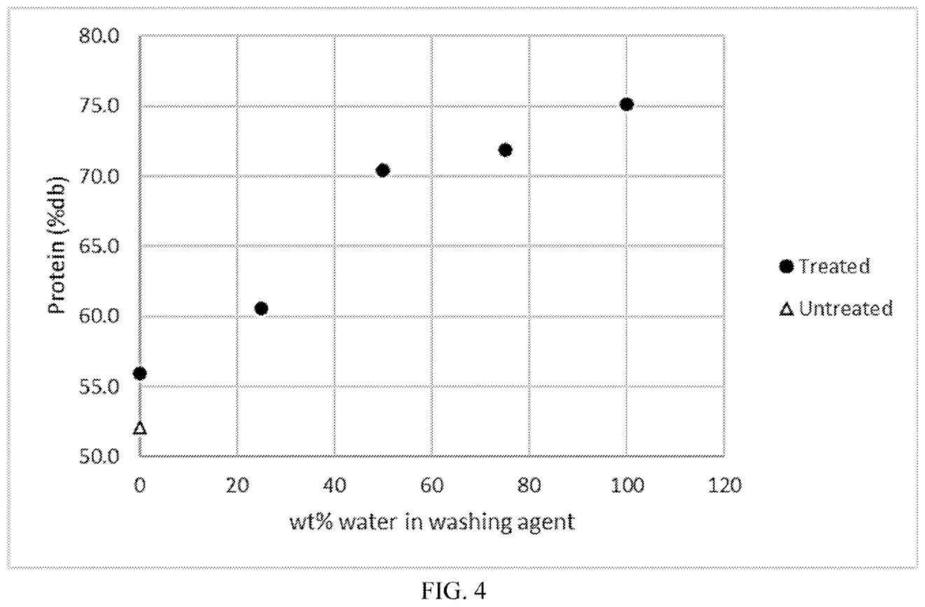

As shown in Table 3 and FIG. 4, the highest protein concentration was obtained after washing with 100% water (i.e., washing agent #1). A trend of decreasing the resulting protein concentration with an increasing ethanol in the washing agent was clearly observed.

TABLE 3
Effect of washing agent composition
on protein concentration (dry basis).

| Washing | Protein Concentration |
|---|---|
| Agent | (%) |
| 1 | 75.2 |
| 2 | 71.9 |
| 3 | 70.5 |
| 4 | 60.6 |
| 5 | 55.9 |
| Unwashed | 55.5 |

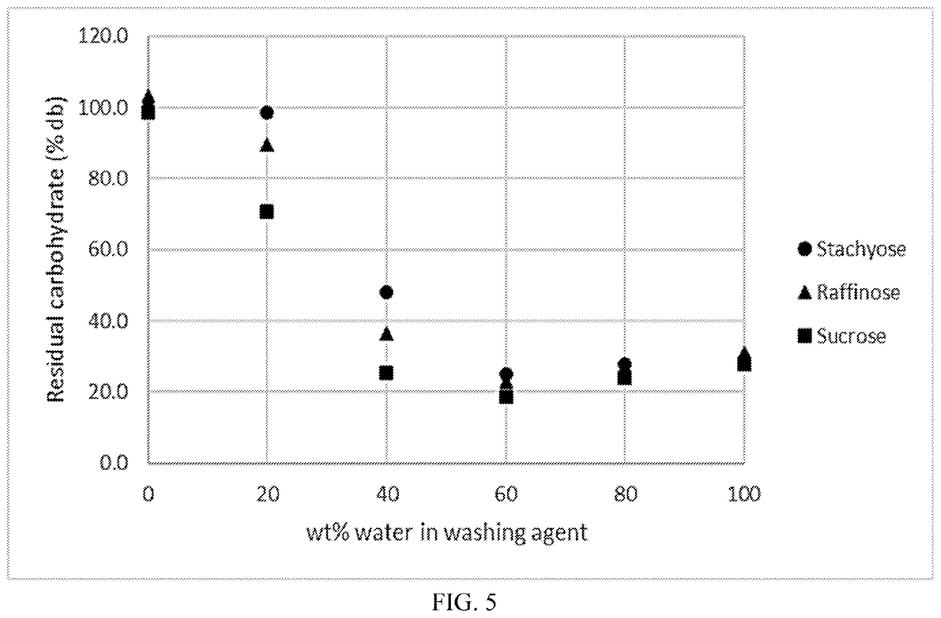

Carbohydrate analysis, as illustrated in Table 4 and FIG. 5, showed significant decreases in all soluble carbohydrates as the amount of water in the washing agent increased. There was a sharp drop in retained sugar when the wash solvent contained at least 40% water. At 20% water, sugars responded differently from each other and grossly proportional to their solubilities in water (sucrose being the most soluble and stachyose being the least).

TABLE 4
Effect of washing agent composition on residual
sugar concentrations (expressed as % as is).

| Washing Agent | Galactose | Fructose | Sucrose | Raffinose | Stachyose | Total |
|---|---|---|---|---|---|---|
| 1 | 0.00 | 0.01 | 2.17 | 0.32 | 1.64 | 4.14 |
| 2 | 0.00 | 0.01 | 2.35 | 0.39 | 2.14 | 4.89 |
| 3 | 0.00 | 0.01 | 1.70 | 0.31 | 1.91 | 3.93 |
| 4 | 0.00 | 0.02 | 5.22 | 0.99 | 5.87 | 12.10 |
| 5 | 0.00 | 0.06 | 8.87 | 1.34 | 6.40 | 16.67 |
| Unwashed | 0.01 | 0.09 | 9.22 | 1.38 | 6.67 | 17.37 |

### Example 3

### Materials and Method

Extruded and ground soybean meal was washed three times to produce extruded and ground soy protein concentrate.

In the first wash, a sample of 5 g extruded soybean meal was suspended in 40 g deionized water in a 50-mL centrifuge tube, mixed and held for 10 minutes at room temperature.

The mixtures were centrifuged 5 minutes at 3000 g. The water was then decanted off to retrieve the first-washed solids.

A second wash began when 30 g of fresh water was mixed with the first-washed solids and held for 10 minutes at room temperature. The mixture was centrifuged 5 minutes at 3000 g. The water was then decanted off to retrieve the second-washed solids.

A third wash began when 30 g of fresh water was mixed with the second-washed solids and held for 10 minutes at room temperature. The mixture was centrifuged 5 minutes at 3000 g. The water was then decanted off to generate the extruded soy protein concentrate. The extruded soy protein concentrates were placed in an aluminum dish and dried at 90° C. Duplicate washed samples were prepared.

Nitrogen was determined using combustion in a Leco device (the standard was BBOT (2,5-di (5-tert-butylbenzoxazol-2-yl)thiophene). A nitrogen-to-protein conversion of 6.25 was used. Loss on drying was obtained by measuring the weight of a sample before and after an overnight drying at 100° C. under vacuum.

### Results and Discussion

As shown in Table 5, washing resulted in protein concentration near 70% on a dry basis. This confirms that water-washing can substantially increase the protein concentration even in the absence of pH and temperature adjustment.

TABLE 5
Protein concentration (dry basis) on unwashed
and washed extruded soybean meal.

| | Protein |
|---|---|
| Sample | Concentration (%) |
| Washed Sample 1 | 72.5 |
| Washed Sample 2 | 69.5 |
| Unwashed | 52.3 |

### Example 4

### Materials and Method

In the first wash, a sample of 200 g extruded soybean meal was mixed with 1000 g of tap water and held for 10 minutes at room temperature. The first-washed solids were collected by filtration through VWR filter paper on a Buchner funnel. The filtrate was weighed and stored refrigerated until analysis. In the second wash, the first-washed solids were resuspended in 1000 g of fresh water at room temperature, held 10 minutes, and filtered as before. The second-washed solids were collected by filtration, and the filtrate was weighed and stored refrigerated. In the third wash, the second-washed solids were resuspended in 1000 g of fresh water at room temperature, held 10 minutes, and filtered as before. The extruded soy protein concentrate solids were collected by filtration, and the complementary filtrate was weighed and stored refrigerated. The extruded soy protein concentrate solids were frozen and then freeze dried.

The moisture of the extruded soy protein concentrate solids and extract were determined using oven drying at 110° C. under vacuum for 2.75 days. Protein was analyzed by Leco on the wet samples. Analyses of amino acid, trypsin inhibitor, phytic acid, raffinose and stachyose were further carried out on the extruded soy protein concentrate solids.

### Results and Discussion

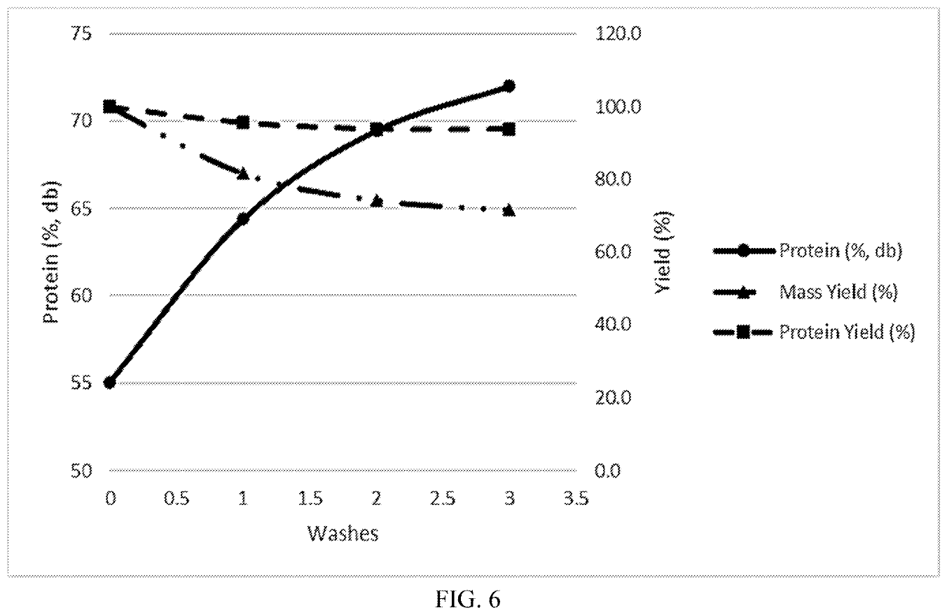

As shown in Table 6 and FIG. 6, the losses in each wash were tracked. In the first wash, about 2.3 g of water per gram of the first-washed solids were retained. Though there was a high concentration of dissolved solids in this extract, close to one-third of the dissolved solids were entrained in the first-washed solids. Based on the mass loss in the extracts, an estimated mass loss was computed. Most of the loss occurred in the first wash with diminished impact from subsequent washes.

TABLE 6
The mass and protein concentrations in
the extracts after the three washes

| | Filtrate | Filtrate | Protein | Mass yield | Protein |
|---|---|---|---|---|---|
| Wash | (g) | solids (g) | (g) | (%) | yield (%) |
| First | 622 | 34.8 | 4.67 | 81.7 | 95.5 |
| Second | 935 | 14.0 | 1.87 | 74.3 | 93.7 |
| Third | 958 | 5.0 | 0 | 71.7 | 93.7 |

Final protein concentration was about 75% in the freeze-dried extruded soy protein concentrate solids. Overall mass yield was about 72% with a protein yield of nearly 94%. The distribution of mass through the process was shown in FIG. 6.

Some components of the washed and unwashed samples were also tracked in Table 7. Percentages were computed based on total protein (sum of amino acids). The washed/unwashed column represented the ratio of each amino acid in the washed sample to its pre-washed concentration.

As shown in Table 7, the only amino acids to change in concentration were non-protein amino acids.

TABLE 7
The amino acid composition of unwashed and washed samples.

| Amino acid | Unwashed | Washed | Washed/Unwashed |
|---|---|---|---|
| Taurine | 0.24 | 0.12 | 0.49 |
| Hydroxyproline | 0.24 | 0.16 | 0.67 |
| Aspartic Acid | 11.47 | 11.39 | 0.99 |
| Threonine | 3.84 | 3.86 | 1.01 |
| Serine | 4.39 | 4.39 | 1.00 |
| Glutamic Acid | 18.39 | 18.16 | 0.99 |
| Proline | 4.84 | 4.97 | 1.03 |
| Lanthionine | 0.08 | 0.06 | 0.73 |
| Glycine | 4.19 | 4.12 | 0.98 |
| Alanine | 4.35 | 4.37 | 1.00 |
| Cysteine | 1.57 | 1.58 | 1.00 |
| Valine | 5.15 | 5.33 | 1.04 |
| Methionine | 1.38 | 1.39 | 1.01 |
| Isoleucine | 5.13 | 5.28 | 1.03 |
| Leucine | 7.85 | 8.15 | 1.04 |
| Tyrosine | 3.48 | 3.28 | 0.94 |
| Phenylalanine | 5.31 | 5.52 | 1.04 |
| Hydroxylysine | 0.04 | 0.03 | 0.73 |
| Ornithine | 0.10 | 0.09 | 0.88 |
| Lysine | 6.59 | 6.48 | 0.98 |
| Histidine | 2.71 | 2.67 | 0.99 |
| Arginine | 7.30 | 7.17 | 0.98 |
| Tryptophan | 1.38 | 1.45 | 1.05 |

Soybean meal contains three materials generally included in a list of antinutritional factors: phytic acid, trypsin inhibitor, and raffinose/stachyose. As shown in Table 8, about ⅓ of the phytic acid was washed away and close to 95% of the two sugars were also washed away.

TABLE 8
Concentrations of antinutritional factors
before wash and after three washes.

| | Before | After Three |
|---|---|---|
| | Wash | Washes |
| Phytic acid (%) | 1.7 | 1.15 |
| Trypsin inhibitor | 3000 | 3100 |
| (trypsin inhibitor unit, TIU) | | |
| Raffinose (%) | 2.00 | 0.09 |
| Stachyose (%) | 4.82 | 0.25 |

### Example 5

### Materials and Method

Three lots of extruded soy protein flour (TSF) (Cargill Incorporated) were obtained. Each lot was divided into washed and unwashed portions.

The unwashed portion was placed in a mylar bag and frozen.

The first wash began when 100 g TSF was mixed with 500 g of water (pre-heated at 65° C.) that contained about 2.5 g of 25 wt % HCl. The resulting suspension was gently mixed to promote hydration and the pH was adjusted to 5.0 (+0.1) with 25 wt % NaOH or 25 wt % HCl, as appropriate. The suspension was then placed in a 65° C. water bath to maintain the temperature for 10 minutes. The liquid and solids were separated using a 100-micron screen with a fitted weight to promote drainage. After draining for 5 minutes, the washed solids were retrieved.

A second wash began when the washed solids were resuspended in fresh 500 g of water (pre-heated at 65° C.) without pH adjustment. The mixture was placed in a 65° C. water bath to maintain the temperature for 10 minutes. Water was drained out using the same screening method as in the first wash to retrieve the twice-washed solids.

A third wash began when the twice-washed solids were resuspended in another fresh 500 g of water (pre-heated at 65° C.) without pH adjustment. The mixture was placed in a 65° C. water bath to maintain the temperature for 10 minutes. Water was drained out using the same screening method as in the first and second washes and the obtained thrice-washed solids were spread on an aluminum sheet. The thrice-washed solids were partially dried at 90° C., and 0% relative humidity (RH) in a Unox Cheftop combi-oven for 30 minutes with stirring at the 10th minute and the 20th minute. The partially dried solids were then brought to the final moisture level (between 2.5 and 7%) using a fluid bed dryer (Sherwood Tornado Model 501) with temperature set at 75° C. for 15 minutes to obtain the treated soy protein product (washed samples). Air flow was adjusted between a setting of 50 and 75 to ensure fluidization of the bed. The washed sample had a final moisture content between 2.5 and 7%.

### Protein Content Evaluation

Moisture was measured by oven drying. Protein was analyzed using an Elementar combustion analyzer using a 6.25 conversion factor for all samples.

TSF raw materials had an average protein content of 55.9 wt %. After washing, the protein content of the washed samples was 75.3 wt. %. Thus, the washing process significantly increased protein content in the treated soy protein product.

### Example 6

### Materials and Method

A sample of extruded soy protein flour (TSF) was collected right after the extrusion process and directly frozen without being dried (i.e., without pre-drying).

100 g of the frozen sample was then thawed and mixed with 500 g of water (pre-heated at 65° C.) that contained about 2.5 g of 25 wt % HCl to begin the first wash. The resulting suspension was gently mixed to promote hydration and the pH was adjusted to 5.0 (±0.1) with 25 wt % NaOH or 25 wt % HCl, as appropriate. The suspension was then placed in a 65° C. water bath to maintain the temperature for 10 minutes. The liquid and solids were separated using a 100-micron screen with a fitted weight to promote drainage. After draining for 5 minutes, the washed solids were retrieved.

A second wash began when the washed solids were resuspended in fresh 500 g of water (pre-heated at 65° C.) without pH adjustment. The mixture was placed in a 65° C. water bath to maintain the temperature for 10 minutes. Water was drained out using the same screening method as in the first wash to retrieve the twice-washed solids.

A third wash began when the twice-washed solids were resuspended in another fresh 500 g of water (pre-heated at 65° C.) without pH adjustment. The mixture was placed in a 65° C. water bath to maintain the temperature for 10 minutes. Water was drained out using the same screening method as in the first and second washes and the obtained thrice-washed solids were spread on an aluminum sheet. The thrice-washed solids were partially dried at 90° C., and 0% relative humidity (RH) in a Unox Cheftop combi-oven for 30 minutes with stirring at the 10^{th} minute and the 20^{th} minute to obtain the treated soy protein product (washed samples). The partially dried solids were then brought to the final moisture level (between 2.5 and 7%) using a fluid bed dryer (Sherwood Tornado Model 501) with temperature set at 75° C. for 15 minutes. Air flow was adjusted between a setting of 50 and 75 to ensure fluidization of the bed. The resulting washed samples had a final moisture content between 2.5 and 7%. Protein concentration was determined using an Elementar combustion apparatus.

### Results and Discussion

Results showed that the protein concentration (on a dry basis) of the washed samples was 68.8% while that of the unwashed sample was 51.3%. Thus, the washing process significantly increased protein content in the treated soy protein product even in the case that the extruded soy protein material (i.e., starting material) was not pre-dried before the washing process.

### Example 7

### Materials and Method

A sample of extruded soy protein flour (TSF) was collected directly from an extruder and had a moisture content of 18 to 20%. The TSF sample was divided into two portions: one with pre-drying (dried portion) before the washing process and the other without the pre-drying (wet portion). Both wet and dry portions were cut into two sizes-size 5 minced (⅛″) and size 10 minced (¼″).

The first wash began when I part of each of the dried and wet portions of TSF were separately mixed with 5 parts of water (pre-heated between 65 and 75° C.). The resulting mixture was gently mixed to promote hydration and the pH was adjusted between 4.7 to 5.2. The mixture, with periodically stirring, was then placed in a water bath of 65 to 75° C., to maintain the temperature for 10 minutes. The liquid and solids were separated using a 100-micron screen with pressing to promote drainage. After draining for 5 minutes, the washed solids were retrieved.

A second wash began when the washed solids were resuspended in fresh 500 g of water (pre-heated between 65 and 75° C.) without pH adjustment. The mixture, with periodically stirring, was then placed in a water bath of 65 to 75° C., to maintain the temperature for 10 minutes. Water was drained out using the same screening method as in the first wash to retrieve the twice-washed solids.

A third wash began when the twice-washed solids were resuspended in another fresh 500 g of water (pre-heated between 65 and 75° C.) without pH adjustment. The mixture, with periodically stirring, was then placed in a water bath of 65 to 75° C., to maintain the temperature for 10 minutes. Water was drained out using the same screening method as in the first and second washes and the obtained thrice-washed solids were spread on an aluminum sheet. The thrice-washed solids were dried at around 75° C. with a final moisture content of 3 to 30%. Protein content of the washed wet and dried portions were evaluated.

### Results and Discussion

As shown in Table 9, pre-drying prior to the washing process was not necessarily required to increase protein content in the final treated soy protein products.

TABLE 9
Protein content of washed wet and dried portions

| Treatment | Protein Content |
|---|---|
| Condition | (Dry Basis) (%) |
| Size 5 minced | 74.4 |
| (1/8″)/dried | |
| Size 5 minced | 72.1 |
| (1/8″)/wet | |
| Size 10 minced | 72.9 |
| (1/4″)/dried | |
| Size 10 minced | 77.6 |
| (1/4″)/wet | |

### Example 8

### Materials and Method

Three lots of extruded soy flour (TSF) (Cargill Incorporated) were obtained. Each lot was divided into washed and unwashed portions.

The unwashed portion was placed in a mylar bag and frozen.

The first wash began when 100 g TSF was mixed with 500 g of water (pre-heated at 65° C.) that contained about 2.5 g of 25 wt % HCl. The resulting suspension was gently mixed to promote hydration and the pH was adjusted to 5.0 (±0.1) with 25 wt % NaOH or 25 wt % HCl, as appropriate. The suspension was then placed in a 65° C. water bath to maintain the temperature for 10 minutes. The liquid and solids were separated using a 100-micron screen with a fitted weight to promote drainage. After draining for 5 minutes, the washed solids were retrieved.

A second wash began when the washed solids were resuspended in fresh 500 g of water (pre-heated at 65° C.) without pH adjustment. The mixture was placed in a 65° C. water bath to maintain the temperature for 10 minutes. Water was drained out using the same screening method as in the first wash to retrieve the twice-washed solids.

A third wash began when the twice-washed solids were resuspended in another fresh 500 g of water (pre-heated at 65° C.) without pH adjustment. The mixture was placed in a 65° C. water bath to maintain the temperature for 10 minutes. Water was drained out using the same screening method as in the first and second washes and the obtained thrice-washed solids were spread on an aluminum sheet. The thrice-washed solids were partially dried at 90° C., and 0% relative humidity (RH) in a Unox Cheftop combi-oven for 30 minutes with stirring at the 10^{th} minute and the 20^{th} minute. The partially dried solids were then brought to the final moisture level (between 2.5 and 7%) using a fluid bed dryer (Sherwood Tornado Model 501) with temperature set at 75° C. for 15 minutes to obtain the treated soy protein product (washed samples). Air flow was adjusted between a setting of 50 and 75 to ensure fluidization of the bed. The resulting washed samples had a final moisture content between 2.5 and 7%.

### Sensory Evaluation

An approach was developed to evaluate attributes of the overall flavor intensity of a product. First, a standardized scale of a given product (e.g., soy flour) was prepared by creating a series of the product with varying intensities via concentration adjustment. Then, the intensity of the washed versions of that given product at a pre-set concentration were compared relative to the standardized scale. This approach provides an objective measure of a change in the aroma and flavor intensity compared to the same reference ingredient.

A composite sample, made with equal portions of the three lots of TSF (raw material), was used to create an intensity reference curve. Samples for the reference curve were prepared by suspending the composite sample in de-ionized water and stirring the mixture for about 10 minutes at room temperature. The mixture was centrifuged and the supernatant was pulled through a Thermo Scientific Nalgene Rapid Flow filter unit (0.2 micron, aPES membrane, ˜660 mmHg vacuum). Solutions were prepared at 0.1, 0.5, 1.0, 2.0, 3.0, and 5.0%. These composite samples were assigned random 3-digit codes and tasted independently by a trained panel (6 panelists) who were asked to place the reference standards in rank order of least to most intense and assign them to an unlabeled line scale. The leftmost (least intense) end of the line scale was water (0%) and the rightmost (most intense) end of the line scale was 5% solution, the rest of the samples distributed in between. The panel leader then reviewed the data of the composite samples for panel agreement of sample intensity rank order and the software assigned numerical values (0-100). Panelists that were deemed outliers were removed and an average of their numerical values was taken for the remaining panelists. Those average values became the scale values (0-100) for the reference standards and were anchored on the line accordingly for the remainder of the tests.

The panel blindly received washed and unwashed samples at 3% concentration and assigned an intensity score to each sample using the reference scale they had created. Three samples of composite samples were also blindly presented to the panel (one with each set of test samples).

Analysis of variance of the results as shown in Table 10 showed that the unwashed samples could not be distinguished from the unwashed composite samples. The overall model had a p<0.001 and an r² value of 0.95. The washed samples were statistically different from the unwashed samples using Tukey's method.

TABLE 10
Overall flavor intensity scores

| | Number of | Mean Intensity |
|---|---|---|
| Test Samples | Samples | Score |
| Composite (unwashed) | 3 | 82.9 |
| Unwashed | 3 | 82.8 |
| Washed | 3 | 32.5 |

A regression line could be fit between the intensity responses and the solutions concentrations (r²=0.96). Rearrangement of the equation allowed calculation of the apparent concentrations of the flavor compounds in the test samples. As shown in the Table 11, the washing process of the present invention decreased the flavor intensity by slightly more than 85%.

TABLE 11
Overall Intensity scores and apparent concentration

| | Mean | Apparent | % Decrease in |
|---|---|---|---|
| | Intensity | Concentration | Overall Flavor |
| Test Samples | Score | (%) | Intensity |
| Composite (unwashed) | 82.9 | 2.69 | 0% |
| Unwashed | 82.8 | 2.68 | 1% |
| Washed | 32.5 | 0.35 | 87% |

### Example 9

### Materials and Method

The first wash began when 150 g extruded soy flour (TSF) (Cargill Incorporated) was mixed with 750 g of water (pre-heated at 65° C.). The resulting suspension (having 5 parts of solution and 1 part of TSF) was mixed and the pH was adjusted to 5.0 (±0.1) with food grade 6M HCl, as appropriate. The suspension was then allowed to incubate for 10 minutes. The liquid and solids were separated using a 250-micron screen with pressure supplied by a 2.3 kg stainless steel plate. After draining for 5 minutes, the washed solids were retrieved.

A second wash began when the washed solids were resuspended in fresh 750 g of water without pH adjustment or addition of CaCl₂). The mixture was allowed to incubate for 10 minutes. Water was drained out using the same screening method as in the first wash to retrieve the twice-washed solids.

A third wash began when the twice-washed solids were resuspended in another fresh 750 g of water without pH adjustment or addition of CaCl₂). The mixture was allowed to incubate for 10 minutes. Water was drained out using the same screening method as in the first and second washes to retrieve the thrice-washed solids. The thrice-washed solids were divided into two parts. A first part of the thrice-washed solids was frozen (wet samples). A second part of the thrice-washed solids were dried at 105° C., and 0% relative humidity (RH) in a convection oven with mixing at 10-minute intervals until the thrice-washed materials were dry. The entire dry process took about 40 minutes.

Table 12 lists the sample designations and treatment conditions. For a washed sample having a target pH of 7, no pH adjustment with any HCl or NaOH treatment was needed. Unwashed samples had an unmodified pH of 6.8 and no further pH adjustment was made.

TABLE 12
Treatment conditions for washing extruded soy flour.

| Treatment | | Dry/Wet |
|---|---|---|
| Condition | Target pH | Sample |
| 1 | 4 | Wet |
| 2 | 4 | Dry |
| 3 | 7 | Wet |
| 4 | 7 | Dry |

### Sensory Evaluation

Samples were prepared by suspending TSF products in water at 5% concentration for 10 minutes at room temperature. The infused solutions were filtered through Thermo Scientific Nalgene Rapid Flow filter unit (0.2 micron, aPES membrane, ˜ 660 mmHg vacuum).

Sample solutions were dosed (about 10 ml) into 1-oz plastic portion cups and capped. Panelists were provided with reference/control product samples and randomly coded “test samples”. Panelists were asked to compare a test sample to a specified control sample and record their responses in EyeQuestion software using a 7-point Likert Scale. Scoring categories were: much less than reference, moderately less than reference, slightly less than reference, not different from the reference, slightly more than reference, moderately more than reference, and much more than reference.

Both aroma and taste/flavor were evaluated. Panelists were provided a set of sensory attribute reference materials to provide guidance to the nature of an aroma and taste/flavor attribute. For example, a rotisserie chicken was provided as an example of roasted chicken aroma.

### Results-Effect of Drying

The comparison of the washed sample under treatment condition 3 (washed sample #3) against unwashed reference showed that 85% of the panelists reported a less roasted chicken aroma in the washed sample #3 as compared to the control, and that 69% of the panelists reported a less intense flavor in the washed sample #3 was compared to the control. Less intense flavor profiles were seen for both beany and cereal-Wheaties aroma and flavor. For beany aroma, 61% of the panelists found it to be less in the washed sample #3 as compared to unwashed samples. For beany flavor, 45% of the panelists tasted it less in the washed sample #3 than control. For cereal-Wheaties aroma, 54% of the panelists sensed it less in the washed sample #3 than control and 46% of the panelists tasted it less in the washed sample #3 as compared to control. Reduced bitterness was another key differentiator, as 46% of the panelists found it be less bitter in the washed sample #3 than control. Panelists reported almost no difference in green aroma, and green and papery flavor.

In the analysis of washed sample under treatment condition 4 (washed sample #4) against unwashed reference, 100% and 92% of panelists found that roasted chicken aroma and taste were lower in the washed sample #4 than control respectively. Beany aroma and taste were less in the washed sample #4 (85% and 61% of the panelists respectively) in contrast to control. Similarly, for cereal-Wheaties aroma, 70% of the panelists sensed it less in the washed sample #4 than control and 61% of the panelists tasted it less in the washed sample #4 as compared to control.

For green aroma, 70% of the panelists sensed it be less in the washed sample #4 than control while 46% of the panelists tasted less in the washed sample #4 as compared to control. This was different from the comparison of washed sample #3 against control where no change was seen. It was worthwhile to note that in addition to weakening the beany and cereal-Wheaties flavors, upon drying, green flavor was reduced too. Sweetness was reduced with no change in umami or bitterness in the washed sample #4 as compared to control.

### Results—Effect of pH

To evaluate the effect of pH, comparisons between the two “dry” washed samples (i.e., washed samples under treatment conditions 2 (washed sample #2) and 4 (washed sample #4)), and between the two “wet” washed samples (i.e., washed samples under treatment conditions 1 (washed sample #1) and 3 (washed sample #3)) were carried out. Results revealed that there were no differences between the two “dry” samples and between the two “wet” samples for any aroma or taste attribute except for more roasted chicken taste and aroma in the washed sample #1 as the washed sample #3: 61% and 46% of the panelists reported the roasted chicken taste and aroma to be more intense in the washed sample #1 (pH4) than the washed sample #3 (pH 7), respectively.

### Results-Untargeted GCMS Analysis

The untargeted GCMS analysis looks at the comprehensive overview of volatile compounds in different plant proteins. This approach is based on the fingerprinting of volatiles on gas chromatography (GC) and hi-resolution mass spectrometric (MS) identification. The overall purpose is to look at the volatile composition of the various samples and compare the different experimental treatments to look for differences and patterns.

Though untargeted GCMS does not provide exact quantitative data, it does provide relative comparative potential. Every compound identified has an associated area count, which is the mass abundance of the fragment ions from the compounds, which can be a relative proxy for concentration. Since different compounds have different sensitivities, one compound cannot be compared to another, but one compound can be compared to itself provided a similar mass fragmentation process was conducted across the samples. Even in this case, the responsiveness may not be perfectly linear, but it is approximately linear.

Samples were subjected to untargeted GCMS to look at the flavor component profiles of the various samples and compare the different experimental treatments to look for differences and patterns. A differential analysis, also known as a “volcano plot”, was generated using the Compound Discoverer software. This graph plotted each individual compound as a dot. The X-axis showed the fold-difference between two samples on a log 2 scale. The Y-axis was the statistical certainty of that difference. Thus, the compounds closest to the origin were the most similarly abundant between the samples, and the compounds which showed the greatest differences in abundance were positioned up and away from the origin. These data can be converted into simple up/down comparison between a reference sample and a “test” sample. If two processes had essentially the same overall effect on two samples, very few compounds with either increase or decrease significantly and would be ignored by this analysis. Table 13 shows results of such a volcano plot.

TABLE 13
The number of compounds that are increased or decreased relative
to a comparative reference sample under various test conditions.

| Reference Samples | Test Samples | Increased | Decreased |
|---|---|---|---|
| pH 4, wet | unwashed | 25 | 67 |
| pH 7, wet | unwashed | 29 | 72 |
| pH 4 dry | unwashed | 14 | 325 |
| pH 7, dry | unwashed | 12 | 348 |
| pH 4, wet | pH 7, wet | 5 | 9 |
| pH 7, dry | pH 4 dry | 9 | 14 |
| pH 4, dry | pH 4, wet | 2 | 288 |
| pH 7, wet | pH 7, dry | 10 | 330 |

### DISCUSSION

In commercial practice, extruded products are often dried to increase microbial stability and decrease the complexity and cost of transport and storage. The sensory results indicates that the washing process of the prevent invention has a strong and desirable effect on the aroma and flavor of the product at either pH. This change is apparently driven by changes in the concentration of a modest number of flavor compounds. Drying has a small additional impact on flavor but a very large effect on the number of flavor compounds removed from the extruded products. As indicated by principal component analysis, both wet and dry samples have a different volatile composition from the unwashed starting material, and wet and dry samples differ from each other.

### Example 10

### Materials and Method

Three lots of extrude soy flour (TSF) (Cargill Incorporated) were obtained. Each lot was divided into washed and unwashed portions.

The unwashed portion was placed in a mylar bag and frozen.

The first wash began when 100 g TSF was mixed with 500 g of water (pre-heated at 65° C.) that contained about 2.5 g of 25 wt % HCl. The resulting suspension was gently mixed to promote hydration and the pH was adjusted to 5.0 (±0.1) with 25 wt % NaOH or 25 wt % HCl, as appropriate. The suspension was then placed in a 65° C. water bath to maintain the temperature for 10 minutes. The liquid and solids were separated using a 100-micron screen with a fitted weight to promote drainage. After draining for 5 minutes, the washed solids were retrieved.

A second wash began when the washed solids were resuspended in fresh 500 g of water (pre-heated at 65° C.) without pH adjustment. The mixture was placed in a 65° C. water bath to maintain the temperature for 10 minutes. Water was drained out using the same screening method as in the first wash to retrieve the twice-washed solids.

A third wash began when the twice-washed solids were resuspended in another fresh 500 g of water (pre-heated at 65° C.) without pH adjustment. The mixture was placed in a 65° C. water bath to maintain the temperature for 10 minutes. Water was drained out using the same screening method as in the first and second washes and the obtained thrice-washed solids were spread on an aluminum sheet. The thrice-washed solids were partially dried at 90° C., and 0% relative humidity (RH) in a Unox Cheftop combi-oven for 30 minutes with stirring at the 10th minute and the 20th minute. The partially dried solids were then brought to the final moisture level (between 2.5 and 7%) using a fluid bed dryer (Sherwood Tornado Model 501) with temperature set at 75° C. for 15 minutes to obtain the treated soy protein product (washed samples). Air flow was adjusted between a setting of 50 and 75 to ensure fluidization of the bed. The resulting washed samples had a final moisture content between 2.5 and 7%.

### Untargeted GCMS Analysis

Samples were subjected to untargeted GCMS to look at the flavor component profiles of the various samples and compare the different experimental treatments to look for differences and patterns. A volcano plot was prepared comparing the washed and unwashed samples. About 680 peaks were observed and a bit more than half were neither increased/decreased more than two-fold and had average peak areas that were significantly different between washed and unwashed. Over six-time as many peaks were decreased in area than increased in area.

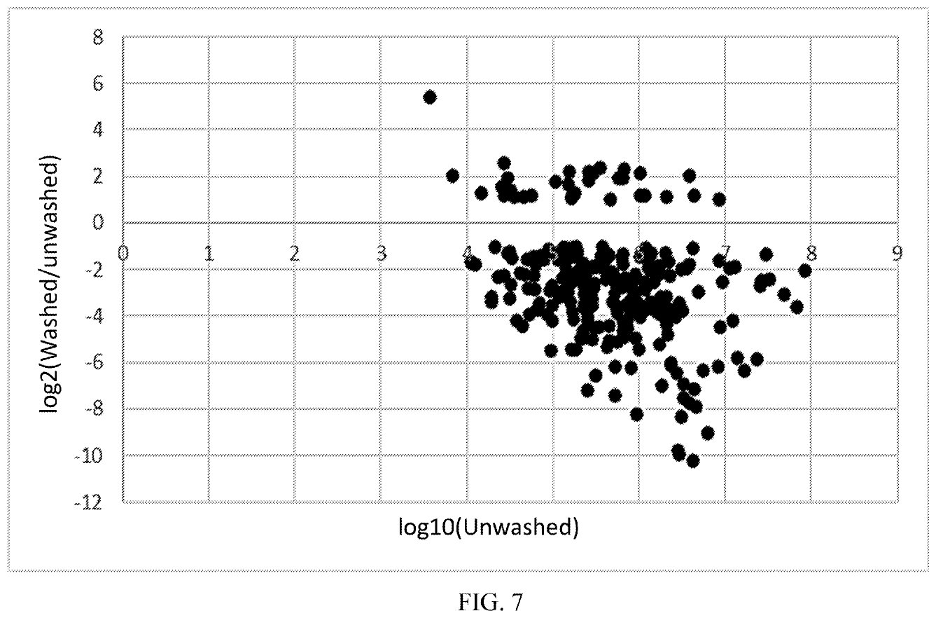

Typically, peaks that were initially small in area increased, while more prominent peaks tended to decrease. This is illustrated in the FIG. 7.

As observed in FIG. 7, a plot of the log base-2 ratio of washed-to-unwashed samples versus the log base-10 concentration of each compound in the unwashed sample, many more compounds were decreased than increased in concentration in the washed samples. It shows that the washing process distinctly changed the compound composition: importantly, the compounds being decreased in concentration are initially high in concentration, while those being increased are relatively low in concentration.

### Example 11

### Materials and Method

Three lots of extrude soy flour (TSF) (Cargill Incorporated) were obtained. Each lot was divided into washed and unwashed portions.

The unwashed portion was placed in a mylar bag and frozen.

The first wash began when 100 g TSF was mixed with 500 g of water (pre-heated at 65° C.) that contained about 2.5 g of 25 wt % HCl. The resulting suspension was gently mixed to promote hydration and the pH was adjusted to 5.0 (+0.1) with 25 wt % NaOH or 25 wt % HCl, as appropriate. The suspension was then placed in a 65° C. water bath to maintain the temperature for 10 minutes. The liquid and solids were separated using a 100-micron screen with a fitted weight to promote drainage. After draining for 5 minutes, the washed solids were retrieved.

A second wash began when the washed solids were resuspended in fresh 500 g of water (pre-heated at 65° C.) without pH adjustment. The mixture was placed in a 65° C. water bath to maintain the temperature for 10 minutes. Water was drained out using the same screening method as in the first wash to retrieve the twice-washed solids.

A third wash began when the twice-washed solids were resuspended in another fresh 500 g of water (pre-heated at 65° C.) without pH adjustment. The mixture was placed in a 65° C. water bath to maintain the temperature for 10 minutes. Water was drained out using the same screening method as in the first and second washes and the obtained thrice-washed solids were spread on an aluminum sheet. The thrice-washed solids were partially dried at 90° C., and 0% relative humidity (RH) in a Unox Cheftop combi-oven for 30 minutes with stirring at the 10th minute and the 20th minute. The partially dried solids were then brought to the final moisture level (between 2.5 and 7%) using a fluid bed dryer (Sherwood Tornado Model 501) with temperature set at 75° C. for 15 minutes to obtain the treated soy protein product (washed samples). Air flow was adjusted between a setting of 50 and 75 to ensure fluidization of the bed. The resulting washed samples had a final moisture content between 2.5 and 7%.

### Volatile Compounds Analysis

Volatile compounds (flavor components/compounds) in plant protein samples can be accurately quantitated by the targeted Gas Chromatography Flame Ionization Detector (GC/FID) analysis. Standards of volatiles of high concentration identified via the untargeted GC/MS analyses were purchased and a method was developed to best separate these volatile compounds from other compounds discovered in plant protein samples chromatographically. GC/FID relies on high resolution separation to ensure baseline resolution of each compound for accurate detection and quantitation. The operation of the FID is based on the detection of ions formed during combustion of volatile organic compounds in a hydrogen flame. The generation of these ions is proportional to the concentration of volatile organic species in the sample gas stream.

Volatile compounds from samples of treated soy protein product are extracted using solid-phase microextraction (SPME). Samples are weighed (0.25 g, the exact mass recorded to the nearest 0.0001 g) directly into a 20 mL headspace screw top vial (Thermo Chromacol 20-HSV). A small magnetic stir bar (VWR J201401) is added to the vial. To the vial, 5 mL of ultrapure water is added, and the vial is capped by a headspace-compatible cap (Gerstel 093640-040-00). The vial is rotated at 30 rpm for 20 minutes to fully mix and release volatiles from the sample matrix into the bulk liquid and headspace. Finally, the vial is loaded into the robotic autosampler for processing during the instrumental run. Replicates of each sample are prepared to remove variability and accurately quantitate the volatile compound levels.

A Gerstel robotic Pro autosampler is installed on the GC instrument. The SPME Fiber installed is a 1.10 mm Divinylbenzene/C-WR/PDMS SPME Arrow (Restek, P/N 27875). The SPME fiber is conditioned in the fiber conditioning unit set at 250° C. for 5 minutes before each sample sequence. In addition, the fiber is re-conditioned to minimize sample carryover by 250° C. for 5 minutes after each injection. For each injection, the SPME needle assembly is pushed through the septum on the vial containing the sample and the SPME fiber is exposed to the headspace: vial penetration is 54 mm and extracted for 90 minutes at 50° C. with stirring (250 rpm). The volatile compounds that are concentrated on the SPME-Arrow fiber are thermally desorbed in the GC inlet for the 90 seconds.

An Agilent 7890 GC is used for separation in this method. A mid-polar column (Restek RTX-624 60 m×250 μm, 1.4 μm film thickness (p/n: 10969), at 1.0 mL/min hydrogen flow.) with a thick film of stationary phase is used to achieve maximum theoretical plates for separation. Hydrogen gas is used as the carrier gas at a low flow rate (1.0 mL/min) to maximize interactions with the stationary phase and increase resolution.

Data is collected and analyzed using Chromeleon™ software. Peaks are integrated automatically by the software and manually checked and/or modified. Peak areas are used to create a calibration curve for each of the ten compounds used to calibrate the method (some compounds use surrogate standards for calibration). Peak areas of each volatile compound are compared to a calibration curve to quantitate the concentration in the sample (multiplied by the dilution factor of the sample preparation that is ˜20×).

The treated soy protein product had a protein content of at least 68% based on a dry basis. Table 14 lists the approximate concentrations of the identified volatile compounds present in the treated soy protein product. All concentrations are present in parts per million (ppm) or parts per billion (ppb) on a dry basis.

TABLE 14
Concentrations of volatile compounds
in treated soy protein products.

Concentration (ppb)

| Volatile compound | Lower Limit | Upper Limit |
|---|---|---|
| 2-Pentyl-furan | 757.6 | 1160.4 |
| Hexanal | 473.9 | 711.7 |
| Benzaldehyde | 75.7 | 90.8 |
| Heptanal | 25.4 | 37.6 |
| 1-Octen-3-ol | 22.8 | 36.3 |
| Octanal | 17.2 | 25.0 |
| 2-Heptanone | 12.5 | 15.8 |
| 2-Ethyl-1-hexanol | 9.3 | 14.4 |
| 2,4-Decandienal | 6.8 | 12.7 |
| 2-Ethyl-furan | 7.8 | 9.7 |
| 2-Butyl-furan | 4.2 | 8.0 |
| 2,4-Nonadienal | 1.9 | 6.8 |
| 2-Ethyl-6-methyl-pyrazine | 3.0 | 5.4 |
| 2-Octanone | 2.1 | 3.5 |
| Tolualdehyde | 1.5 | 3.4 |
| 2-Nonanone | 2.1 | 2.1 |
| 4-Ethyl-benzaldehyde | 1.0 | 1.1 |
| 1-Pentanol | 0.5 | 1.2 |
| 2-Hexanol | 0.0 | 0.0 |
| 2-Hexanone | 0.0 | 0.0 |
| 2-Propyl-furan | 0.0 | 0.0 |

As observed in Table 15, the washing process of the present invention significantly reduced concentration of many volatile compounds in the treated soy protein product. Five volatile compounds were shown to be almost completely eliminated from the treated soy protein product, while seventeen volatile compounds were shown to be removed from the treated soy protein product by at least 50%.

TABLE 15
Reduction of volatile compounds in treated soy protein products.

| | Decrease in concentration (%) | | |
|---|---|---|---|
| Volatile compound | Mean | Lower Limit | Upper Limit |
| 2-Hexanol | 100 | 100 | 100 |
| 2-Hexanone | 100 | 100 | 100 |
| 2-Propyl-furan | 100 | 100 | 100 |
| 2-Ethyl-furan | 99 | 98 | 99 |
| 2-Heptanone | 90 | 89 | 92 |
| 2-Octanone | 89 | 87 | 91 |
| 2-Butyl-furan | 88 | 86 | 91 |
| 2-Nonanone | 88 | 87 | 89 |
| 1-Pentanol | 84 | 82 | 87 |
| 1-Octen-3-ol | 83 | 80 | 86 |
| Benzaldehyde | 78 | 72 | 84 |
| Heptanal | 75 | 68 | 83 |
| Tolualdehyde | 70 | 59 | 82 |
| 2-Pentyl-furan | 69 | 63 | 74 |
| Hexanal | 65 | 51 | 80 |
| 2-Ethyl-1-hexanol | 62 | 55 | 70 |
| 4-Ethyl-benzaldehyde | 60 | 50 | 69 |
| Octanal | 40 | 28 | 53 |
| 2,4-Decandienal | 21 | 8 | 34 |
| 2-Ethyl-6-methyl-pyrazine | −8 | −56 | 40 |
| 2,4-Nonadienal | −8 | −52 | 36 |

### Example 12

### Materials and Method

Three lots of extrude soy flour (TSF) (Cargill Incorporated) were obtained.

The first wash began when TSF was mixed with water (pre-heated at 65° C.) at a mass ratio of, TSF to water, 1:10. The pH of the resulting suspension was adjusted to 5 and the suspension was then placed in a 65° C. water bath to maintain the temperature for 10 minutes. The water was removed by filtration through an aluminum screen for 5 minutes (with no drainage apparently visible after 3 minutes). After draining for 5 minutes, the washed solids were retrieved.

A second wash began when the washed solids were resuspended in fresh water (pre-heated at 65° C.) at a mass ratio of, washed solids to water, 1:7.5. The mixture was placed in a 65° C. water bath to maintain the temperature for 10 minutes. Water was drained out using the same screening method as in the first wash to retrieve the twice-washed solids.

A third wash began when the twice-washed solids were resuspended in fresh water (pre-heated at 65° C.) at a mass ratio of, washed solids to water, 1:7.5. The mixture was placed in a 65° C. water bath to maintain the temperature for 10 minutes. Water was drained out using the same screening method as in the first and second washes and the obtained thrice-washed solids were dried at 115° C., overnight under vacuum.

Samples of the starting TSF materials (i.e., unwashed TSF) and the corresponding washed TSF were analyzed by inductively coupled plasma (ICP-OES). All values were corrected to a dry weight basis before statistical analysis.

### Results and Discussion

As shown in Table 16. TSF had an extremely low Na concentration to begin with and increased slightly through treatment. Metal ions such as Cu, K, and Mg were at lower concentrations after washing. Phosphorus content was also reduced after washing.

TABLE 16
Metal ions and phosphorus content in treated soy protein products.

| | | |
|---|---|---|
| Metal Ion | | |
| Concentration (ppm) | Average | Average |

| | Unwashed | Washed | change (ppm) | change % |
|---|---|---|---|---|
| Ca | 3,427 | 3,477 | 50 | 1% |
| Cu | 16 | 14 | −1.80 | −11% |
| Fe | 81 | 93 | 11.19 | 14% |
| K | 25,225 | 6,196 | −19,028 | −75% |
| Mg | 3,142 | 1,723 | −1,419.4 | −45% |
| Na | 14 | 22 | 8.7 | 62% |
| P | 8,689 | 6,504 | −2,185 | −25% |

### Example 13

### Materials and Method

Three lots of extruded soy flour (TSF) (Cargill Incorporated) were obtained. Each lot was divided into washed and unwashed portions.

The unwashed portion was placed in a mylar bag and frozen.

The first wash began when 100 g TSF was mixed with 500 g of water (pre-heated at 65° C.) that contained about 2.5 g of 25 wt % HCl. The resulting suspension was gently mixed to promote hydration and the pH was adjusted to 5.0 (+0.1) with 25 wt % NaOH or 25 wt % HCl, as appropriate. The suspension was then placed in a 65° C. water bath to maintain the temperature for 10 minutes. The liquid and solids were separated using a 100-micron screen with a fitted weight to promote drainage. After draining for 5 minutes, the washed solids were retrieved.

A second wash began when the washed solids were resuspended in fresh 500 g of water (pre-heated at 65° C.) without pH adjustment. The mixture was placed in a 65° C. water bath to maintain the temperature for 10 minutes. Water was drained out using the same screening method as in the first wash to retrieve the twice-washed solids.

A third wash began when the twice-washed solids were resuspended in another fresh 500 g of water (pre-heated at 65° C.) without pH adjustment. The mixture was placed in a 65° C. water bath to maintain the temperature for 10 minutes. Water was drained out using the same screening method as in the first and second washes and the obtained thrice-washed solids were spread on an aluminum sheet. The thrice-washed solids were partially dried at 90° C., and 0% relative humidity (RH) in a Unox Cheftop combi-oven for 30 minutes with stirring at the 10th minute and the 20th minute. The partially dried solids were then brought to the final moisture level (between 2.5 and 7%) using a fluid bed dryer (Sherwood Tornado Model 501) with temperature set at 75° C. for 15 minutes to obtain the treated soy protein product (washed samples). Air flow was adjusted between a setting of 50 and 75 to ensure fluidization of the bed. The washed sample had a final moisture content between 2.5 and 7%.

### Odor Evaluation

Some aroma-active compounds (e.g., sulfur-containing compounds) have a very low sensory threshold and humans can detect them in products at very low levels (parts per trillion). These sorts of compounds exist in products at levels that instrumental detectors typically cannot detect. As such, the human nose is far more sensitive for these compounds and gas chromatography olfactometry (GC-O) utilizes the human nose as the primary detector.

A composite sample, made with equal portions of the three lots of TPP (raw material), was analyzed by GC-O. A washed sample, made from one of the lots in the composite sample was also tested.

Samples for GC-O analysis were prepared by adding 10 ml ultrapure water to 0.5 g washed and 0.5 g unwashed composite samples in separate 20 ml GC headspace vials. Samples were mixed by rotation for 20 minutes at 30 rpm. Samples were incubated at 50° C. with stirring for 5 minutes and extracted with solid phase microextraction Arrow (SPME-Arrow) Divinylbenzene/Polydimethylsiloxane (DVB/PDMS) fiber for 30 minutes at 50° C. with stirring.

Two individuals with 6 and 13 years of GC-O experience smelled the GC column effluent and logged “odor events” by pressing a button to capture the GC runtime and a recording of their spoken description of the odor. Each panelist ran each sample in duplicate (i.e., 2 panelists×2 replicates=4 total GC-O runs for each sample). The total number of odor events for washed or unwashed samples were averaged.

As shown in Table 17, this GC-O analysis approach showed washing of TSF reduced the average total of odor events by 33% of the unwashed sample.

TABLE 17
GC-O analysis

| | Unwashed | Washed |
|---|---|---|
| | Composite Sample | Sample |
| Average Number of Odor Events | 36.0 | 24.2 |
| Odor Events Reduced (%) | — | 33% |

### Example 14

### Materials and Method

Three lots of extrude soy protein flour (TSF) (Cargill Incorporated) were obtained. Each lot was divided into washed and unwashed portions.

The unwashed portion was placed in a mylar bag and frozen.

The first wash began when 100 g TSF was mixed with 500 g of water (pre-heated at 65° C.) that contained about 2.5 g of 25 wt % HCl. The resulting suspension was gently mixed to promote hydration and the pH was adjusted to 5.0 (±0.1) with 25 wt % NaOH or 25 wt % HCl, as appropriate. The suspension was then placed in a 65° C. water bath to maintain the temperature for 10 minutes. The liquid and solids were separated using a 100-micron screen with a fitted weight to promote drainage. After draining for 5 minutes, the washed solids were retrieved.

A second wash began when the washed solids were resuspended in fresh 500 g of water (pre-heated at 65° C.) without pH adjustment. The mixture was placed in a 65° C. water bath to maintain the temperature for 10 minutes. Water was drained out using the same screening method as in the first wash to retrieve the twice-washed solids.

A third wash began when the twice-washed solids were resuspended in another fresh 500 g of water (pre-heated at 65° C.) without pH adjustment. The mixture was placed in a 65° C. water bath to maintain the temperature for 10 minutes. Water was drained out using the same screening method as in the first and second washes and the obtained thrice-washed solids were spread on an aluminum sheet. The thrice-washed solids were partially dried at 90° C., and 0% relative humidity (RH) in a Unox Cheftop combi-oven for 30 minutes with stirring at the 10th minute and the 20th minute. The partially dried solids were then brought to the final moisture level (between 2.5 and 7%) using a fluid bed dryer (Sherwood Tornado Model 501) with temperature set at 75° C. for 15 minutes to obtain the treated soy protein product (washed samples). Air flow was adjusted between a setting of 50 and 75 to ensure fluidization of the bed. The washed sample had a final moisture content between 2.5 and 7%.

### Carbohydrate Content Evaluation

Carbohydrate quantitation on the samples was performed by High Pressure Ion Chromatography (HPIC), separated by a CarboPac™ PA1 column using Pulsed Amperometric Detection (PAD).

As shown in Table 18, the washed and unwashed samples had different soluble carbohydrate profiles, with some sugars being rendered absent by the washing treatment.

TABLE 18
Concentration of carbohydrates in treated soy protein products.

Concentration (ppm)

| Saccharide | Lower Limit | Upper Limit |
|---|---|---|
| Sucrose | 13,593 | 70,226 |
| Raffinose | 1,909 | 9,872 |
| Stachyose | 10,195 | 48,107 |

The effect of washing itself is revealed by the sample-by-sample mean change in concentration due to washing. As shown in Table 19, the washing process of the present invention significantly reduced concentration of many carbohydrates present in the treated soy protein product.

TABLE 19
Reduction of carbohydrates in treated soy protein products.

| | Decrease in concentration (%) | | |
|---|---|---|---|
| Saccharide | Mean | Lower Limit | Upper Limit |
| Sucrose | 81 | 80 | 81 |
| Raffinose | 82 | 81 | 82 |
| Stachyose | 79 | 78 | 79 |

### Free Amino Acid Evaluation

Free amino acid concentrations were analyzed before and after washing by UHPLC/UV utilizing pre-column derivatization with diethyl ethoxymethylenemalonate (DEEMM) and separated by reversed phase C18 column.

Table 20 lists the approximate concentrations of the identified free amino acids present in the treated soy protein product. All concentrations are present in parts per million (ppm) on a dry basis. In general, the concentrations of free amino acids dropped significantly after washing.

TABLE 20
Concentration of free amino acids in treated soy protein products.

Concentration (ppm)

| Amino Acids | Lower Limit | Upper Limit |
|---|---|---|
| Histidine | 16.5 | 19.2 |
| Serine | 8.0 | 9.0 |
| Arginine | 156.0 | 171.4 |
| Aspartic acid | 74.3 | 87.8 |
| Glycine | 106.5 | 123.8 |
| Glutamic acid | 93.6 | 114.9 |
| Threonine | 9.4 | 10.4 |
| Alanine | 28.2 | 36.1 |
| Tyrosine | 46.3 | 49.2 |
| Methionine | 6.9 | 7.3 |
| Valine | 9.9 | 11.7 |
| Tryptophan | 82.7 | 92.3 |
| Phenylalanine | 23.5 | 27.5 |
| Isoleucine | 11.8 | 14.0 |
| Leucine | 10.5 | 12.2 |
| Lysine | 14.1 | 16.1 |
| Total | 728 | 773 |

To account for potential variation in the starting material, pair differences are computed and analyzed. Results are shown in Table 21 in which the mean decrease (%) of the washed samples against the unwashed samples is expressed as the 95% confidence interval.

The change in concentration caused by washing process ranged from about 40% to 90%. Thus, the washing process of the present invention significantly reduced concentration of many free amino acids in the treated soy protein product.

TABLE 21
Free amino acids mean change.

| | Decrease in Concentration (%) | | |
|---|---|---|---|
| Amino Acids | Mean | Lower Limit | Upper Limit |
| Histidine | 69 | 68 | 71 |
| Serine | 73 | 69 | 76 |
| Arginine | 79 | 78 | 80 |
| Aspartic acid | 86 | 85 | 87 |
| Glycine | 44 | 38 | 50 |
| Glutamic acid | 86 | 85 | 87 |
| Threonine | 74 | 73 | 75 |
| Alanine | 82 | 81 | 82 |
| Tyrosine | 59 | 56 | 62 |
| Methionine | 68 | 67 | 68 |
| Valine | 81 | 80 | 82 |
| Tryptophan | 70 | 69 | 71 |
| Phenylalanine | 76 | 76 | 77 |
| Isoleucine | 78 | 77 | 79 |
| Leucine | 77 | 76 | 78 |
| Lysine | 76 | 75 | 77 |
| Total | 78 | 77 | 79 |

### Example 15

### Materials and Method

Three lots of extrude soy protein flour (TSF) (Cargill Incorporated) were obtained. Each lot was divided into washed and unwashed portions.

The unwashed portion was placed in a mylar bag and frozen.

The first wash began when 100 g TSF was mixed with 500 g of water (pre-heated at 65° C.) that contained about 2.5 g of 25 wt % HCl. The resulting suspension was gently mixed to promote hydration and the pH was adjusted to 5.0 (±0.1) with 25 wt % NaOH or 25 wt % HCl, as appropriate. The suspension was then placed in a 65° C. water bath to maintain the temperature for 10 minutes. The liquid and solids were separated using a 100-micron screen with a fitted weight to promote drainage. After draining for 5 minutes, the washed solids were retrieved.

A second wash began when the washed solids were resuspended in fresh 500 g of water (pre-heated at 65° C.) without pH adjustment. The mixture was placed in a 65° C. water bath to maintain the temperature for 10 minutes. Water was drained out using the same screening method as in the first wash to retrieve the twice-washed solids.

A third wash began when the twice-washed solids were resuspended in another fresh 500 g of water (pre-heated at 65° C.) without pH adjustment. The mixture was placed in a 65° C. water bath to maintain the temperature for 10 minutes. Water was drained out using the same screening method as in the first and second washes and the obtained thrice-washed solids were spread on an aluminum sheet. The thrice-washed solids were partially dried at 90° C., and 0% relative humidity (RH) in a Unox Cheftop combi-oven for 30 minutes with stirring at the 10th minute and the 20th minute. The partially dried solids were then brought to the final moisture level (between 2.5 and 7%) using a fluid bed dryer (Sherwood Tornado Model 501) with temperature set at 75° C. for 15 minutes to obtain the treated soy protein product (washed samples). Air flow was adjusted between a setting of 50 and 75 to ensure fluidization of the bed. The washed sample had a final moisture content between 2.5 and 7%.

Two lots of extruded soy concentrate (unwashed conventional samples) that was made by conventional methods and did not undergo the washing process of the present invention were obtained. The mean protein concentration (on dry basis) in the washed samples was 75.3%, while the mean protein concentration (on dry basis) of the unwashed samples was 73.9%.

### Carbohydrate Content Evaluation

Carbohydrate quantitation on the samples was performed by High Pressure Ion Chromatography (HPIC), separated by a CarboPac™ PA1 column using Pulsed Amperometric Detection (PAD).

As shown in Table 22, the washed and unwashed samples had different soluble carbohydrate profiles. Washed samples had lower raffinose concentration than the unwashed samples.

TABLE 22
Carbohydrates in washed and unwashed conventional samples.

| | Concentration (ppm) | | |
|---|---|---|---|
| | Unwashed | | |
| | conventional | | |
| Saccharide | samples | Washed samples | p-value |
| Fructose | 0.84 | 0 | 0.374 |
| Sucrose | 3,861 | 13,593 | 0.001 |
| Raffinose | 10,934 | 1,909 | 0.001 |
| Stachyose | 10,680 | 10,195 | 0.754 |

### Metal Ion Concentration Evaluation

The washed and unwashed conventional samples were analyzed by inductively coupled plasma (ICP-OES). All values were corrected to a dry weight basis before statistical analysis.

A comparison of the metal ion concentrations in Table 23 showed that Ca and Na concentrations could not be distinguished between the washed samples and the unwashed conventional samples. The washed samples had lower concentrations in iron, magnesium, and potassium concentrations than unwashed conventional samples. Phosphorus content was also lower in the washed samples.

TABLE 23
Metal ions in washed and unwashed conventional samples.

| | Metal Ion Concentration (ppm) | | |
|---|---|---|---|
| | Unwashed | | p- |
| Metal Ions | conventional samples | Washed samples | Value |
| Ca | 3,794 | 3,477 | 0.267 |
| Cu | 9.9 | 13.9 | 0.022 |
| Fe | 116.9 | 92.7 | 0.047 |
| K | 21,534 | 6,196 | <0.001 |
| Mg | 3,181 | 1,723 | <0.001 |
| Na | 110 | 22.2 | 0.141 |
| P | 8,863 | 6,504 | <0.001 |

### Free Amino Acid Evaluation

Free amino acid concentrations were analyzed for the washed and unwashed conventional samples by UHPLC/UV utilizing pre-column derivatization with diethyl ethoxymethylenemalonate (DEEMM) and separated by reversed phase C18 column.

The washed samples were compared to the unwashed conventional samples for free amino acid concentrations. As shown in Table 24, there was no significant difference in the concentrations of free alanine, glutamic acid, and methionine. The concentrations of histidine, serine, arginine, aspartic acid, lysine, and total free amino acids were lower in the washed samples than the unwashed conventional samples. In contrast, the concentrations of glycine, threonine, tyrosine, valine, tryptophan, phenylalanine, isoleucine, and leucine were higher in the washed samples than the unwashed conventional samples.

TABLE 24
Free amino acids in washed and unwashed conventional samples.

| | Concentration (ppm) | | |
|---|---|---|---|
| | Unwashed | | |
| Amino Acids | conventional samples | Washed samples | p-value |
| Histidine | 49 | 18 | <0.001 |
| Serine | 29 | 8.5 | <0.001 |
| Arginine | 1,096 | 164 | <0.001 |
| Aspartic acid | 173 | 81 | 0.001 |
| Glycine | 22 | 115 | <0.001 |
| Glutamic acid | 85 | 104 | 0.07 |
| Threonine | 7.2 | 9.9 | 0.006 |
| Alanine | 32 | 32 | 0.972 |
| Tyrosine | 35 | 48 | 0.002 |
| Methionine | 7.6 | 7.1 | 0.101 |
| Valine | 2.4 | 11 | 0.001 |
| Tryptophan | 20 | 88 | <0.001 |
| Phenylalanine | 15.7 | 25.5 | 0.006 |
| Isoleucine | 5.8 | 13 | 0.002 |
| Leucine | 7.2 | 11 | 0.005 |
| Lysine | 58 | 15 | <0.001 |
| Total | 1,586 | 751 | <0.001 |

As shown in Table 25, in a comparison of the washed samples to two unwashed conventional samples, five aldehydes (hexanal, heptanal, 4-ethyl-benzaldehyde, 2,4-nonadienal, and 2,4-decandienal), three ketones (2-heptanone, 2-octanone, and 2-nonanone), one furan (2-pentyl-furan), and one pyrazine (2-ethyl-6-methyl-pyrazine) compound showed no significant (p<0.05) difference in concentration.

All four alcohols (1-octen-3-ol, 1-pentanol, 2-ethyl-1-hexanol, and 2-hexanol) were lower in unwashed conventional sample, perhaps due to the standard aqueous EtOH washing used in that material's production.

Benzaldehyde was lower in washed samples than unwashed conventional samples, but octanal and tolualdehyde had a significantly higher concentration. 2-hexanone was the only ketone to show a significant difference between the washed samples and the unwashed conventional samples; the washed samples had the higher concentration.

Three furans (2-ethyl-furan, 2-butyl-furan, and 2-propyl-furan) were significantly higher in the washed samples than the conventional samples.

TABLE 25
Volatile compounds in washed and
unwashed conventional samples.

| | Concentration (ppm) | | |
|---|---|---|---|
| | Unwashed | Washed | |
| Volatile compound | conventional samples | samples | p-value |
| 1-Octen-3-ol | 0.067 | 0.174 | 0.001 |
| 1-Pentanol | 0.000 | 0.005 | 0.021 |
| 2-Ethyl-1-hexanol | 0.010 | 0.032 | 0.023 |
| 2-Hexanol | 0.000 | 0.005 | 0.002 |
| Hexanal | 0.440 | 1.954 | 0.15 |
| Heptanal | 0.063 | 0.130 | 0.077 |
| Benzaldehyde | 0.719 | 0.397 | 0.014 |
| Octanal | 0.002 | 0.036 | 0.011 |
| 4-Ethyl-benzaldehyde | 0.003 | 0.003 | 0.844 |
| 2,4-Nonadienal | 0.019 | 0.005 | 0.082 |
| 2,4-Decandienal | 0.008 | 0.013 | 0.172 |
| Tolualdehyde | 0.003 | 0.008 | 0.011 |
| 2-Ethyl-furan | 0.086 | 0.684 | 0.019 |
| 2-Penty1-furan | 1.469 | 3.092 | 0.07 |
| 2-Butyl-furan | 0.021 | 0.053 | 0.039 |
| 2-Propyl-furan | 0.017 | 0.103 | 0.009 |
| 2-Heptanone | 0.119 | 0.148 | 0.406 |
| 2-Octanone | 0.023 | 0.025 | 0.548 |
| 2-Hexanone | 0.001 | 0.004 | 0.017 |
| 2-Nonanone | 0.016 | 0.018 | 0.226 |
| 2-Ethyl-6-methyl- | 0.005 | 0.004 | 0.89 |
| pyrazine | | | |

Overall, it is clear that extruded soy flour can be washed in a way that makes it compositionally distinct from conventional extruded soy products (e.g., extruded soy concentrate). One skilled in the art will recognize that the process described above could be modified to increase (or decrease) the differences between the two ingredients.

What is claimed is:

1. A method of making a treated soy protein product, comprising the steps of:
a. providing an extruded soy protein material; and
b. performing a washing step on the extruded soy protein material to obtain the treated soy protein product, wherein the washing step comprises washing the extruded soy protein material at a washing temperature of room temperature to 85° C. with a washing agent;
wherein the treated soy protein product has at least 70 wt % protein on a dry basis; and the washing agent to the extruded soy protein material in the washing step is in a ratio of 4:1 to 40:1; wherein the treated soy protein product has one or more improved attributes compared to the extruded soy protein material, wherein the one or more improved attributes are selected from the group consisting of an increased protein content, a reduced flavor component content, a reduced metal ion content, a reduced odor content, a reduced carbohydrate content, a reduced free amino acid content, and any combinations thereof.

2. (canceled)

3. The method of claim 1, further comprising a step of:
c. drying the treated soy protein product at a drying temperature of 75° C., to 120° C.

4. The method of claim 1, wherein one or more process parameters of the method are the same or different in each washing step, and the one or more process parameters are selected from the group consisting of a ratio of the washing agent to the extruded soy protein material, pH of the washing agent, washing temperature, and duration of washing

5.-7. (canceled)

8. The method of claim 1, the extruded soy protein material is provided directly from an extruder without any intermittent pre-drying step before the washing step, and wherein the extruded soy protein material has a moisture content of 15 to 25%; and the extruded soy protein material is selected from the group consisting of an extruded soy flour and an extruded soybean meal.

9. (canceled)

10. A method of making a treated soy protein product, consisting of the steps of:
a. providing an extruded soy protein material; and
b. performing a washing step on the extruded soy protein material to obtain the treated soy protein product, wherein the washing step consists of washing the extruded soy protein material at a washing temperature of room temperature to 85° C. with water; and
c. drying the treated soy protein product at a drying temperature of 75 to 120° C.;
wherein the treated soy protein product has at least 70 wt % protein on a dry basis; and the ratio of water to the extruded soy protein material in the washing step is from 4:1 to 40:1; wherein the treated soy protein product has one or more improved attributes compared to the extruded soy protein material, wherein the one or more improved attributes are selected from the group consisting of an increased protein content, a reduced flavor component content, a reduced metal ion content, a reduced odor content, a reduced carbohydrate content, a reduced free amino acid content, and any combinations thereof.

11. (canceled)

12. The method of claim 10, wherein one or more process parameters of the method are the same or different in each washing step, and the one or more process parameters are selected from the group consisting of a ratio of the washing agent to the extruded soy protein material, pH of the washing agent, washing temperature, and duration of washing.

13. The method of claim 10, wherein the extruded soy protein material is selected from the group consisting of an extruded soy flour and an extruded soybean meal; and the treated soy protein product is an extruded soy protein concentrate.

14.-15. (canceled)

16. A treated soy protein product having one or more improved attributes compared to an unwashed extruded soy protein material or an equivalent unwashed extruded soy protein product, wherein the one or more improved attributes are selected from the group consisting of an increased protein content, a reduced flavor component content, a reduced metal ion content, a reduced odor content, a reduced carbohydrate content, a reduced free amino acid content, and any combinations thereof.

17. (canceled)

18. The treated soy protein product of claim 16, wherein the flavor component is selected from the group consisting of furan, pyran, organic acid, aldehyde, alcohol, ketone, pyrazine, lactone, thiol, sulfide, lactone, and any combinations thereof.

19. The treated soy protein product of claim 16, wherein the reduced flavor component content is selected from the group consisting of a lower furan content, a lower aldehyde content, a lower alcohol content, a lower ketone content, a lower pyrazine content, and any combinations thereof, compared to an unwashed extruded soy protein material.

20.-22. (canceled)

23. The treated soy protein product of claim 16, wherein the flavor component is selected from the group consisting of 2-pentyl-furan, hexanal, benzaldehyde, heptanal, 1-octen-3-ol, octanal, 2-heptanone, 2-ethyl-1-hexanol, 2-ethyl-furan, 2-butyl-furan, 2-octanone, tolualdehyde, 2-nonanone, 4-ethyl-benzaldehyde, 1-pentanol, 2-hexanol, 2-hexanone, 2,4-nonadienal, 2-ethyl-6-methyl-pyrazine, and 2-propyl-furan.

24. The treated soy protein product of claim 16, having one or more flavor components content at least 20%, preferably at least 40%, more preferably at least 50%, lower than the one or more flavor components content of an unwashed extruded soy protein material, wherein the one or more flavor components are selected from the group consisting of 2-hexanol, 2-hexanone, 2-propyl-furan, 2-ethyl-furan, or 2-heptanone, 2-octanone, 2-butyl-furan, 2-nonanone, 1-octen-3-ol, benzaldehyde, heptanal, tolualdehyde, 2-pentyl-furan, hexanal, 2-ethyl-1-hexanol, 4-ethyl-benzaldehyde, and octanal.

25. The treated soy protein product of claim 16, wherein one or more flavor component content is at least 90%, preferably at least 95%, more preferably at least 99%, lower than the one or more flavor components content of an unwashed extruded soy protein material, wherein the one or more flavor components are selected from the group consisting of 2-hexanol, 2-hexanone, and 2-propyl-furan.

26. The treated soy protein product of claim 16, wherein the metal ion is selected from the group consisting of calcium ion, copper ion, iron ion, potassium ion, magnesium ion, and sodium ion.

27. The treated soy protein product of claim 16, having one or more metal ions content at least 10%, preferably at least 30%, more preferably at least 50%, lower than the one or more ions content of an unwashed extruded soy protein material, wherein the one or more ions are selected from copper ion, potassium ion, magnesium ion, and any combinations thereof.

28. (canceled)

29. The treated soy protein product of claim 16, wherein the carbohydrate is selected from the group consisting of sucrose, raffinose, stachyose, and any combinations thereof.

30. The treated soy protein product of claim 16, having one or more carbohydrates content at least 70%, preferably at least 75%, more preferably at least 80%, lower than the one or more carbohydrates content of an unwashed extruded soy protein material, wherein the one or more carbohydrates are selected from the group consisting of sucrose, raffinose, stachyose, and any combinations thereof.

31. The treated soy protein product of claim 16, having one or more free amino acid content at least 80%, preferably at least 85%, more preferably at least 90%, lower than the one or more free amino acids content of an unwashed extruded soy protein material, wherein the one or more free amino acids are selected from the group consisting of aspartic acid, glutamic acid, alanine, valine, histidine, serine, arginine, lysine, and any combinations thereof.

32.-39. (canceled)

40. The treated soy protein product of claim 16, which is made by the method of claim 1.
